(19) United States
(12) Patent Application Publication
(10) Pub. No.: US 2016/0209997 A1
(43) Pub. Date: Jul. 21, 2016

(54) APPARATUS AND METHOD FOR DISPLAYING CONNECTION STATUS IN NETWORK

(71) Applicant: Samsung Electronics Co., Ltd., Gyeonggi-do (KR)

(72) Inventors: Dongik LEE, Gyeonggi-do (KR); Apoorv KANSAL, Gyeonggi-do (KR); Inho PARK, Seoul (KR); Younseog CHANG, Gyeonggi-do (KR)

(73) Assignee: Samsung Electronics Co., Ltd.

(21) Appl. No.: 14/997,134

(22) Filed: Jan. 15, 2016

(30) Foreign Application Priority Data
Jan. 15, 2015 (KR) 10-2015-0007373

(51) Int. Cl. G06F 3/0482; G06F 3/0481; G06F 3/0484; H04L 29/08

(52) U.S. Cl. CPC G06F 3/0482; H04L 67/12; H04L 67/10; H04L 67/36; G06F 3/04815; G06F 3/04842

(57) ABSTRACT

The present disclosure relates to a sensor network, Machine Type Communication (MTC), Machine-to-Machine (M2M) communication, and technology for Internet of Things (IoT). The present disclosure may be applied to intelligent services based on the above technologies, such as smart home, smart building, smart city, smart car, connected car, health care, digital education, smart retail, security and safety services. A method and apparatus of a first electronic device, a second electronic device, and a server in a network are provided. The method for operating a first electronic device in a network includes determining a sub-step in progress among a plurality of sub-steps of a connection procedure with a second electronic device; and displaying information about the sub-step.

### PRIORITY

This application claims priority under 35 U.S.C. §119(a) to a Korean Patent Application filed in the Korean Intellectual Property Office on Jan. 15, 2015, and assigned Serial No. 10-2015-0007373, the contents of which are incorporated herein by reference.

### BACKGROUND OF THE DISCLOSURE

1. Field of the Disclosure

The present disclosure relates generally to a method and apparatus for displaying a connection status between devices in a network.

2. Description of the Related Art

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched.

Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

Owing to the growth of communication technologies and users' demand for high-quality services, electronic devices having communication functions are gradually increasing in scope. For example, the prior generation of electronic devices (e.g., refrigerators, air conditioners, illumination devices, etc.), i.e., those which independently perform inherent functions without communication with other devices, have communication functions, which make them capable of providing additional and more convenient services than that which they traditionally provide, such as remote control, interaction with the other devices, etc. Such services require a network connection between devices. Generally, a connection status of an electronic device is displayed as an On or Off status. In other words, information about the connection status merely notifies connection completion or connection non-completion. For example, a connection status between an illumination device and a mobile terminal can be divided into an On status and an Off status by colors. Accordingly, a user can know only a result of success or failure of a connection procedure of a corresponding electronic device, and cannot know which step of the connection setup procedure is being currently performed, or the cause if the connection is not made.

### SUMMARY

The present disclosure has been made to address at least the problems and disadvantages described above, and to provide at least the advantages described below.

Accordingly, an aspect of the present disclosure provides an apparatus and method for providing information about a connection procedure between electronic devices in a network.

Accordingly, another aspect of the present disclosure provides an apparatus and method for providing information about sub-steps of a connection procedure between electronic devices in a network.

Accordingly, another aspect of the present disclosure provides an apparatus and method for providing information about the cause of interruption of a sub-step of a connection procedure between electronic devices in a network.

Accordingly, another aspect of the present disclosure provides an apparatus and method for re-executing an interrupted sub-step of a connection procedure between electronic devices in a network.

Accordingly, another aspect of the present disclosure provides an apparatus and method for providing supplementary information of electronic devices in a network.

Accordingly, another aspect of the present disclosure provides an apparatus and method for using 3-Dimensional (3D) rendering to express information about sub-steps of a connection procedure between electronic devices in a network.

Accordingly, another aspect of the present disclosure provides an apparatus and method for providing estimated time information about sub-steps of a connection procedure between electronic devices in a network.

Accordingly, another aspect of the present disclosure provides an apparatus and method for providing information about sub-steps of a connection procedure between electronic devices in a network, from multiple angles through a plurality of electronic devices.

In accordance with an aspect of the present disclosure, a method for operating a first electronic device in a network is provided. The method includes determining a sub-step in progress among a plurality of sub-steps of a connection procedure with a second electronic device, and displaying information about the sub-step.

In accordance with another aspect of the present invention, a method for operating a second electronic device in a network is provided. The method includes outputting information about a sub-step in progress among a plurality of sub-steps of a connection procedure with a first electronic device, during the connection procedure, where the information about the sub-step is output in a form of at least one of an image, a character, a numeral, a sound, lighting, displaying, and vibrating.

In accordance with another aspect of the present disclosure, a method of a server managing information about a connection procedure between electronic devices is provided. The method includes receiving, from a first electronic device, information about a second electronic device to connect with the first electronic device, and transmitting an estimated time for performing at least one of a plurality of sub-steps of a connection procedure between the first electronic device and the second electronic device.

In accordance with another aspect of the present disclosure, a first electronic device in a network is provided. The first electronic device includes a controller that determines a sub-step in progress among a plurality of sub-steps of a connection procedure with a second electronic device, and a display unit that displays information about the sub-step.

In accordance with another aspect of the present disclosure, a second electronic device in a network is provided. The second electronic device includes an output unit that outputs information about a sub-step in progress among a plurality of sub-steps of a connection procedure with a first electronic device, during the connection procedure, where the information about the sub-step is output in a form of at least one of an image, a character, a numeral, a sound, lighting, displaying, and vibrating.

In accordance with another aspect of the present disclosure, a server apparatus managing information about a connection procedure between electronic devices is provided. The server apparatus includes a reception unit that receives, from a first electronic device, information about a second electronic device to connect with the first electronic device, and a transmission unit that transmits an estimated time for performing at least one of a plurality of sub-steps of a connection procedure between the first electronic device and the second electronic device.

### BRIEF DESCRIPTION OF THE DRAWINGS

The above and other objects, features, and advantages of the present disclosure will become more apparent from the following detailed description taken in conjunction with the accompanying drawings, in which:

FIG. 1 is a block diagram of a network configuration, according to an embodiment of the present disclosure;

FIG. 2 is a process flow diagram of sub-steps of a connection procedure in a network, according to an embodiment of the present disclosure;

FIG. 3 is a flowchart for a procedure of monitoring a connection procedure in an electronic device, according to an embodiment of the present disclosure;

FIG. 4 illustrates a logical configuration of an electronic device, according to an embodiment of the present disclosure;

FIG. 5 illustrates a method of visually distinguishing sub-steps of a connection procedure in an electronic device, according to an embodiment of the present disclosure;

FIG. 6 illustrates an interface for displaying a connection status in an electronic device, according to an embodiment of the present disclosure;

FIGS. 7A and 7B illustrate interface elements and an interface for displaying a connection status in an electronic device, according to embodiment of the present disclosure;

FIGS. 8A and 8B illustrate interface elements and an interface for displaying a connection status in an electronic device, according to another embodiment of the present disclosure;

FIGS. 9A to 9C illustrate interface elements and an interface for displaying a connection status in an electronic device, according to another embodiment of the present disclosure;

FIG. 10 illustrates a procedure for displaying a connection status in an electronic device, according to an embodiment of the present disclosure;

FIG. 11 illustrates an interface element for displaying a connection status in an electronic device, according to an embodiment of the present disclosure;

FIG. 12 illustrates a method of displaying supplementary information through an interface element for displaying a connection status in an electronic device, according to an embodiment of the present disclosure;

FIG. 13 illustrates a method of displaying supplementary information through an interface element for displaying a connection status in an electronic device, according to another embodiment of the present disclosure;

FIG. 14 illustrates a procedure for displaying supplementary information in an electronic device, according to an embodiment of the present disclosure;

FIG. 15 illustrates a procedure for displaying a connection status in an electronic device, according to an embodiment of the present disclosure;

FIG. 16 illustrates a procedure for displaying a connection status in an electronic device, according to another embodiment of the present disclosure;

FIG. 17 illustrates a procedure for displaying supplementary information in an electronic device, according to another embodiment of the present disclosure;

FIG. 18 illustrates a procedure of displaying a connection status in an electronic device, according to another embodiment of the present disclosure;

FIG. 19 is a flowchart for a procedure for displaying a connection status in an electronic device, according to an embodiment of the present disclosure;

FIG. 20 is a flowchart of an operation procedure of an electronic device, according to an embodiment of the present disclosure;

FIG. 21 is a flowchart of an operation procedure of an electronic device, according to another embodiment of the present disclosure;

FIG. 22 is a flowchart of an operation procedure of an electronic device, according to another embodiment of the present disclosure;

FIG. 23 is a flowchart of an operation procedure of a server managing information about a connection procedure, according to an embodiment of the present disclosure;

FIG. 24 is a flowchart of an operation procedure of an electronic device, according to a another embodiment of the present disclosure;

FIG. 25 is a block diagram of a configuration of an electronic device, according to an embodiment of the present disclosure;

FIG. 26 is a block diagram of a configuration of a server managing information about a connection procedure, according to an embodiment of the present disclosure; and

FIG. 27 is a block diagram of a configuration of an external device, according to another embodiment of the present disclosure.

### DETAILED DESCRIPTION OF EMBODIMENTS OF THE PRESENT DISCLOSURE

Embodiments of the present disclosure will be described herein with reference to the accompanying drawings. Those of ordinary skill in the art will recognize that various changes and modifications to the embodiments described herein may be made without departing from the scope and the spirit of the present disclosure. In describing the present disclosure, well-known functions or constructions may be omitted so as not to obscure the invention in unnecessary detail.

The terms and words used in the following description and claims are not limited to their dictionary meanings, but are merely used to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

The present disclosure describes a technology for displaying a connection status between devices in a network. More specifically, the present disclosure describes a technology for displaying a subdivided connection status, during the course of a connection process for service provision between devices connecting to the network.

The term “unit” represents a module or component for processing at least one function or operation. A unit may be implemented by hardware, software, or a combination of hardware and software.

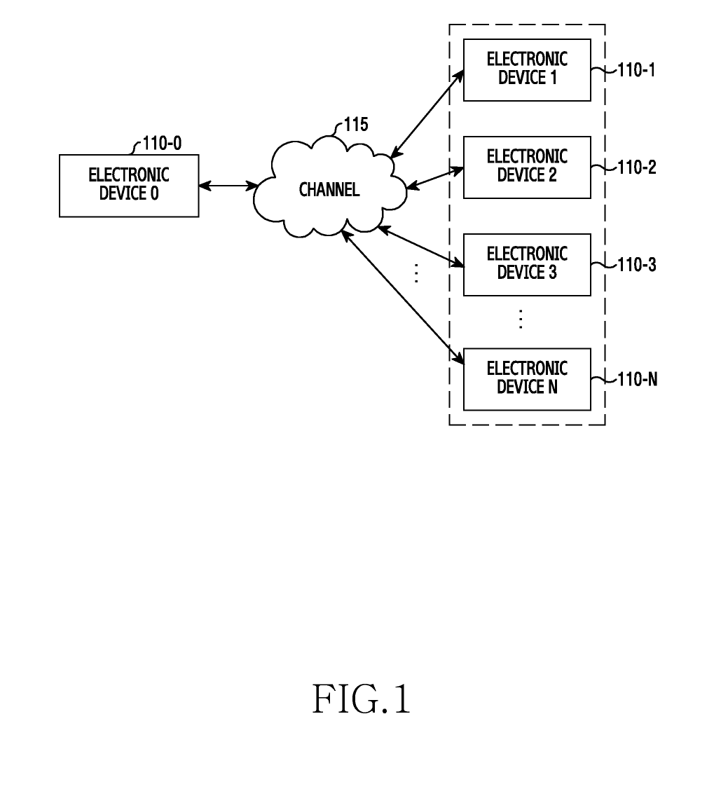

FIG. 1 is a block diagram of a network configuration, according to an embodiment of the present disclosure.

Referring to FIG. 1, the network includes a plurality of electronic devices 110-0 to 110-N, and a channel 115.

Electronic device 0 110-0 is connected with electronic device 1 110-1 to electronic device N 110-N through the channel 115. The electronic device 0 110-0 collects and displays information of a detailed step for connection with the electronic device 1 110-1 to the electronic device N 110-N. The electronic device 0 110-0 may be, for example, a smartphone, a tablet Personal Computer (PC), a mobile phone, a video phone, an electronic book (e-book) reader, a netbook computer, a Personal Digital Assistant (PDA), a Portable Multimedia Player (PMP), an MP3 player, a mobile medical device, a camera, a wearable device, a desktop PC, or a laptop PC, or a combination of them.

The channel 115 is a path for signal exchange between the plurality of electronic devices 110-0 to 110-N. The channel 115 is comprised of at least one wired channel, at least one wireless channel, or a combination of the at least one wired channel and the at least one wireless channel. Further, the channel 115 may include other devices. The channel 115 may be used by technologies of a wireless Local Area Network (LAN), Bluetooth, Zigbee, or ZigWave, etc.

The electronic device 1 110-1 to the electronic device N 110-N may be connected with the electronic device 0 110-0 through the channel 115 wirelessly or by wire. The electronic device 1 110-1 to the electronic device N 110-N each may be a device of the same or similar kind to that of the electronic device 0 110-0, or various Internet of Things (IoT) devices used at a home or office.

For example, the electronic device 1 110-1 to the electronic device N 110-N may be a set-top box, a television (TV), a washer, a refrigerator, an air conditioner, a system air conditioner, an illumination device, an oven, an air cleaner, and a printer, or a combination of them.

The electronic device 1 110-1 to the electronic device N 110-N may be a smart home appliance having a communication function. The smart home appliance may, for example, include at least one of a television, a Digital Versatile Disk (DVD) player, an audio system, a refrigerator, an air conditioner, a cleaner, an oven, a microwave, a washer, an air conditioner, a set-top box, a TV box (for example, Samsung HomeSync™, Apple TV™, or Google TV™, a game console, an electronic dictionary, an electronic locking system, a camcorder, or an electronic frame.

The electronic device 1 110-1 to the electronic device N 110-N may include at least one of various medical devices (e.g., Magnetic Resonance Angiography (MRA) machine, Magnetic Resonance Imaging (MRI) machine, Computerized Tomography (CT) machine, a moving-camera, an ultrasonic machine, etc.), a navigation device, a Global Positioning System (GPS) receiver, an Event Data Recorder (EDR), a Flight Data Recorder (FDR), a car infotainment device, an electronic equipment for a ship (e.g., a navigation device for a ship, a gyrocompass, etc.), avionics, a security device, a head unit for car, an industrial or home robot, an Automatic Teller Machine (ATM, or a Point Of Sales (POS) machine.

Alternatively, the electronic device 1 110-1 to the electronic device N 110-N may include at least one of a part of furniture or building/structure including a communication function, an electronic board, an electronic signature receiving device, a projector, or various metering devices (e.g., tap water, electricity, gas, or radio wave metering device).

In accordance with various embodiments of the present disclosure, the plurality of electronic devices 110-0 to 110-N each is one of the aforementioned various devices or a combination of two or more of them. Also, in accordance with various embodiments of the present disclosure, the plurality of electronic devices 110-0 to 110-N each is a flexible device. Also, in accordance with various embodiments of the present disclosure, it is obvious to those skilled in the art that the plurality of electronic devices 110-0 to 110-N each are not limited to the aforementioned devices.

According to one embodiment, the network is a telecommunications network. The telecommunications network may include at least one of a computer network, the Internet, Internet of Things, or a telephone network. In accordance with one embodiment, a protocol (e.g., a transport layer protocol, a data link layer protocol, or a physical layer protocol) for communication between the plurality of electronic devices 110-0 to 110-N is supported in at least one of an application, an application programming interface, a middleware, a kernel, or a communication interface.

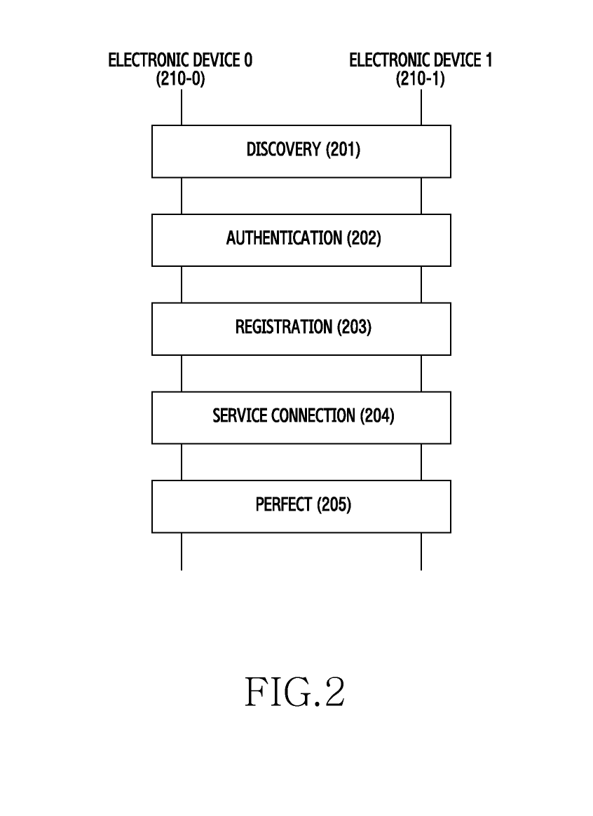

FIG. 2 is a process flow diagram of sub-steps of a connection procedure in a network, according to an embodiment of the present disclosure.

Referring to FIG. 2, a procedure to connect electronic device 0 210-0 and electronic device 1 210-1 is provided. The connection procedure is subdivided into sub-steps which represent a time order or an operation order of the connection procedure. The following sub-steps are shown, discovery step 201, authentication step 202, registration step 203, service connection step 204, and perfect step 205. The discovery step 201 may alternatively be referred to as a ‘search step’, and the registration step 203 may alternatively be referred to as a ‘pairing step’.

The discovery step 201 is a process in which the electronic device 0 210-0 discovers service-connectable neighboring other devices. The electronic device 0 210-0 multicasts or broadcasts a signal for discovering other devices. The electronic device 1 210-1 may detect the signal from the electronic device 0 210-0. In this case, and the electronic device 1 210-1 transmits a response signal, responsive to the detected signal, to the electronic device 0 210-0. By receiving the response signal from the electronic device 1 210-1, the electronic device 0 210-0 discovers the electronic device 1 210-1. That is, through the response signal, the electronic device 0 210-0 is able to check a search result of at least one other device.

If discovery succeeds, that is, if the response signal is received from the electronic device 1 210-1, the electronic device 0 210-0 proceeds with the authentication step 202. If the discovery fails, that is, if no response signal is received from the electronic device 1 210-1, the electronic device 0 210-0 checks identification information (i.e., identity) of a discovery target device. The electronic device 0 210-0 checks if the discovery target device is a new device or has a previously discovered history. Whether the history exists may be determined on the basis of Internet Protocol (IP) address, authentication, or registration related information. If the history exists, the electronic device 0 210-0 performs a ping test using history information. The ping test is for determining if communication is available, in other words, determining if a valid connection exists. The ping test is carried out by transmitting and receiving a test signal. In compliance with a communication standard, the ping test may be referred to by other names. For example, a beacon signal may be used for the purpose of the ping test.

If the ping test succeeds, the electronic device 0 210-0 re-executes the discovery step 201 for the target device. If the discovery again fails, the electronic device 0 210-0 attempts to execute a control instruction for the target device. In other words, to determine if control of the target device is available, the electronic device 0 210-0 requests to execute a specific function (e.g., Light Emitting Diode (LED) flickering, sound output, etc.) of the target device. If the control through the control instruction succeeds, the electronic device 0 210-0 increases an abnormal count by 1. If the abnormal count exceeds a threshold value, the electronic device 0 210-0 determines that the target device is in a service module unstable state, and proposes rebooting of the target device to a user. In contrast, if the abnormal count is equal to or is less than the threshold value, the electronic device 0 210-0 may re-execute the discovery step 201. In contrast, if the control through the control instruction fails, the electronic device 0 210-0 determines that the target device is in the service module unstable state, and proposes the rebooting of the target device to the user.

If the target device is new or if the ping test fails, the electronic device 0 210-0 may determine network pairing or non-pairing of the target device. The network pairing or non-pairing is determined according to storage or non-storage of identification information (e.g., an IP address, a node address, etc.) at a network level of the target device. If the network pairing is valid, the electronic device 0 210-0 may increase the abnormal count by 1. If the abnormal count exceeds the threshold value, the electronic device 0 210-0 determines that it is an error state, and proposes the rebooting of the target device to the user. In contrast, if the abnormal count is equal to or is less than the threshold value, the electronic device 0 210-0 may re-execute the discovery step 201. In contrast, if the network pairing is invalid, the electronic device 0 210-0 may attempt a network pairing procedure.

The authentication step 202 is a process of determining if a service connection can be made between a user, a device, or an application between the electronic device 0 210-0 and the electronic device 1 210-1. For the authentication step 202, authentication information of the user, the device, or the application is exchanged. Here, the authentication information may be provided automatically, without a user's intervention, or through a user's direct input. Any one of the electronic device 0 210-0 and the electronic device 1 210-1 may provide authentication information and the other one of them may verify the provided authentication information, thereby performing the authentication step 202. The verification is performed through comparison between the provided authentication information and previously registered information.

If authentication succeeds, the electronic device 0 210-0 proceeds with the registration step 203. If the authentication fails, the electronic device 0 210-0 determines whether correction of authentication information is available. That is, the electronic device 0 210-0 checks if a setting of the authentication information is previously configured or is dynamically configured. If the correction of the authentication information is available, the electronic device 0 210-0 corrects the authentication information of the target device and then, re-executes the authentication step 202. Here, the authentication information may be corrected according to a predefined pattern, or according to a user's input. In contrast, if the correction of the authentication information is not available, the electronic device 0 210-0 increases an abnormal count by 1. If the abnormal count exceeds a threshold value, the electronic device 0 210-0 notifies the user that external technology support is needed.

The registration step 203 is a process of providing and recording information of any one of the electronic device 0 210-0 and the electronic device 1 210-1 to the other one. The information may include identification information, capability information of software and hardware of a device, etc. For the electronic device 0 210-0 to setup a connection with the electronic device 1 210-1, identification information of the electronic device 0 210-0 is registered to the electronic device 1 210-1. If the registration information is consistent, it is determined that a registration procedure is processed normally.

If registration succeeds, the electronic device 0 210-0 proceeds with the service connection step 204. If the registration fails, the electronic device 0 210-0 determines if correction of registration information is available. The registration information is defined in accordance with the kind of service. If correction of the registration is available, the electronic device 0 210-0 corrects the registration information of the target device and then, re-executes the registration step 203. Here, the registration information may be corrected in accordance with a predefined pattern, or in accordance with a user's input. In contrast, if correction of the registration information is not available, the electronic device 0 210-0 increases an abnormal count by 1. If the abnormal count exceeds a threshold value, the electronic device 0 210-0 may notify the user that external technology support is needed.

The service connection step 204 is the final process of setting up a connection between the electronic device 0 210-0 and the electronic device 1 210-1. The service connection step 204 is a process of actually making a connection between a controller and a controllee on a network. For example, the service connection step 204 is a process of activating a service intended to be provided between the electronic device 0 210-0 and the electronic device 1 210-1. The service connection step 204 may include a connection/setup process in an application layer. The service connection step 204 is normally carried out as long as there is not a hindrance, etc. on a communication path.

The perfect step 205 represents that the connection setup is successfully made between the electronic device 0 210-0 and the electronic device 1 210-1. That is, the perfect step 205 is a step representing that a control or service connection has been normally perfected between the electronic device 0 210-0 and the electronic device 1 210-1. The perfect step 205, denotes a status, and thus includes no signaling or operation.

The connection procedure illustrated in FIG. 2 has been divided into five sub-steps. However, the connection procedure may be subdivided in other manners. For example, two or more of the sub-steps illustrated in FIG. 2 may be merged into one sub-step, or at least one sub-step may be separated into a plurality of sub-steps. For example, the connection procedure may be divided into four or less steps or six or more steps. While the present disclosure is described below with respect to the five sub-steps illustrated in FIG. 2, the scope of the present disclosure is not limited to this, and may be equally applied to a connection procedure capable of being divided into a plurality of sub-steps.

Also, the sub-steps of the connection procedure illustrated in FIG. 2 may be mapped with detailed steps of a connection procedure at a network level for the purpose of enabling data communication. Furthermore, after the data communication is achieved, the sub-steps of the connection procedure illustrated in FIG. 2 may be mapped with detailed steps of a connection procedure in an upper layer for a service. Alternatively, the sub-steps of the connection procedure illustrated in FIG. 2 may be mapped with detailed steps of both the connection procedure at the network level and the connection procedure in the upper layer.

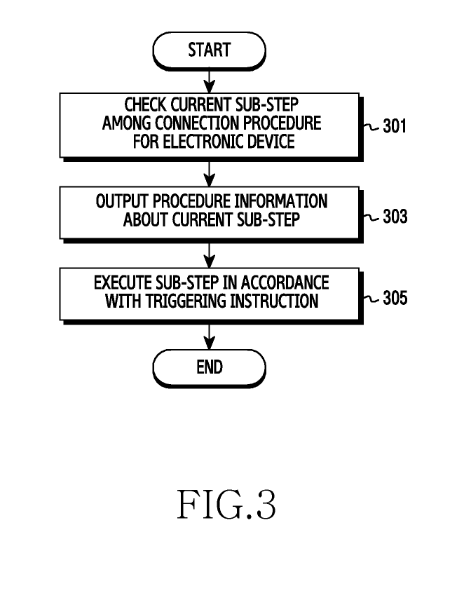

FIG. 3 is a flowchart for a procedure of monitoring a connection procedure in an electronic device, according to an embodiment of the present disclosure.

Referring to FIG. 3, the electronic device 110-0 may be connected with at least one other device by a wired network or wireless network. Particularly, the electronic device 110-0 may be wirelessly connected with other devices, such as electronic devices 110-0 to 110-N, through a wireless network (e.g., a wireless LAN network, a Bluetooth network, a Zigbee network, and a ZigWave network). The wireless network may include all wired/wireless networks in which a controller can display a connection status with a controllee.

In step 301, the electronic device 110-0 determines a sub-step of a connection procedure currently in progress for at least one or more of the electronic devices 110-0 to 110-N. That is, the electronic device 110-0 determines if a connection status corresponds to any one of the discovery, authentication, registration, service connection, or perfect steps for connection with one or more of the electronic devices 110-0 to 110-N.

In step 303, the electronic device 110-0 outputs procedure information about the determined current sub-step. The electronic device 110-0 displays the determined sub-step through a display means. The procedure information about the sub-step expresses which sub-step is currently in progress. In addition, the procedure information may further include supplementary information about a corresponding one of the electronic devices 110-0 to 110-N.

In step 305, the electronic device 110-0 executes any one sub-step in accordance with a triggering instruction corresponding to the procedure information. The triggering instruction may include a user's instruction for procedure execution input through a User Interface (UI) or an electronic device's instruction for procedure execution, etc.

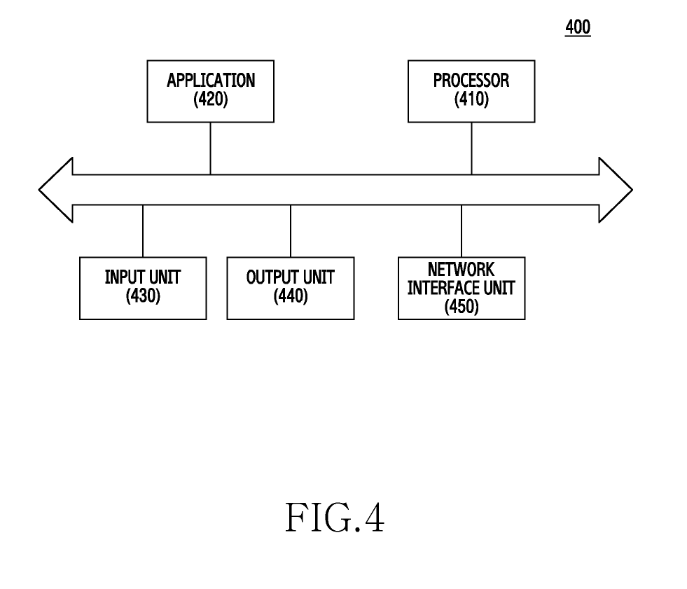

FIG. 4 illustrates a logical configuration of an electronic device, according to an embodiment of the present disclosure.

Referring to FIG. 4, components of electronic device 400 (e.g., electronic devices 110-0 to 110-N) are shown. The electronic device 400 includes a processor 410, an application 420, an input unit 430, an output unit 440, and a network interface unit 450.

The processor 410 may include one or more of a Central Processing Unit (CPU), an Application Processor (AP), and a Communication Processor (CP). The processor 410 executes control of at least one other constituent element of the electronic device 400, an operation associated with communication, data processing, etc.

The application 420 is a set of instructions configured to provide an intended service. The application 420 includes instructions for a service provided based on communication with other devices.

The input unit 430, a component for interaction with a user, recognizes a user's input. The input unit 430 includes at least one of a touch panel, a pen sensor, at least one key, and an ultrasonic input device. The touch panel employs at least one scheme among an electrostatic scheme, a pressure sensitive scheme, an infrared scheme, and an ultrasonic scheme. The touch panel may also include a control circuit. The touch panel may further include a tactile layer, thereby providing a tactile response to a user.

The output unit 440 provides a result to the user. For example, the output unit 440 includes a display means capable of outputting an image, a video, etc. In detail, the display means may include at least one of a Liquid Crystal Display (LCD), a Light Emitting Diode (LED), a Light emitting Polymer Display (LPD), an Organic LED (OLED), an Active Matrix Organic Light Emitting Diode (AMOLED), and a Flexible LED (FLED). Also, the output unit 440 may include a means (e.g., a speaker) capable of outputting a sound.

The network interface unit 450 provides an interface for communication between the electronic device 400 and other devices. That is, the network interface unit 450 may perform connection with at least one other device. The network interface unit 450 may perform the connection with the other device using a wired network or a wireless network. For example, the network interface unit 450 generates a transmission signal in accordance with a protocol for a supported communication standard, or interprets a reception signal. For example, the network interface unit 450 may support at least one communication technology among a wireless LAN, Bluetooth, Zigbee, and ZigWave.

The electronic device 400 provides information about a sub-step of a connection procedure with another device, to a user. For example, the sub-steps of the connection procedure may be identified through at least one of a color, a graphic pattern, an image, and a text.

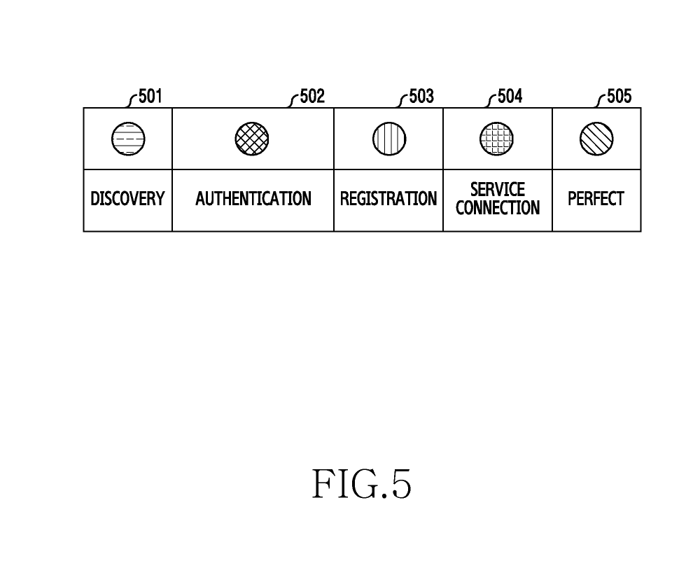

FIG. 5 illustrates a method of visually distinguishing sub-steps of a connection procedure in an electronic device, according to an embodiment of the present disclosure.

Referring to FIG. 5, a discovery step 501, an authentication step 502, a registration step 503, a service connection step 504, and a perfect step 505 are shown distinguished visually through different graphic patterns. Alternatively or additionally, steps 501 to 505 may be distinguished in other manners, such as through a color, an additional image, or an additional text.

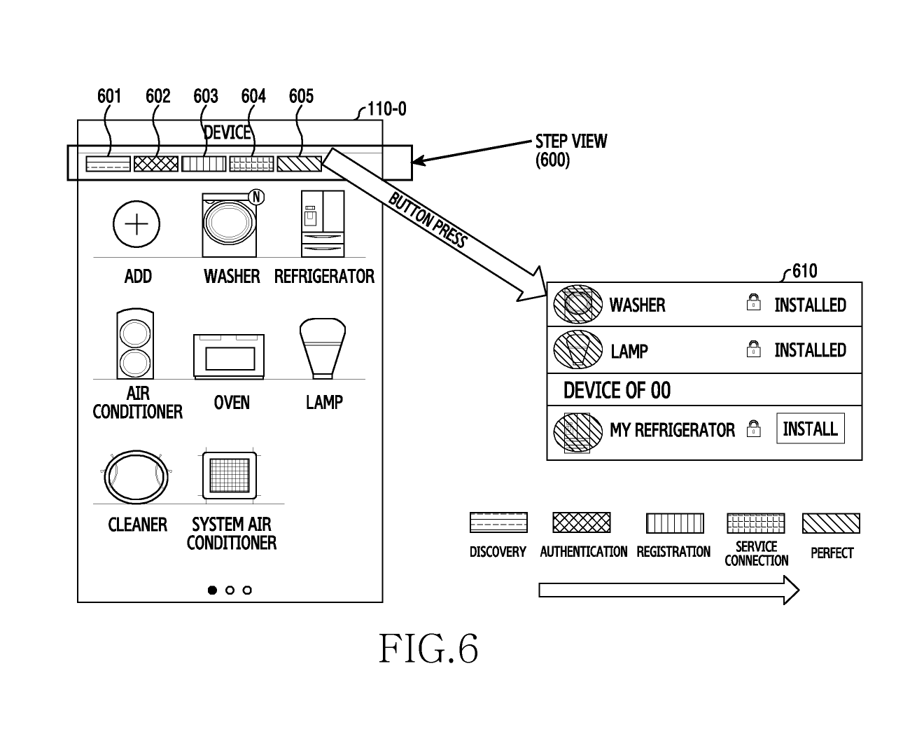

FIG. 6 illustrates an interface for displaying a connection status in an electronic device, according to an embodiment of the present disclosure.

Referring to FIG. 6, a connection status interface of electronic device 110-0 is provided. The connection status interface includes icons of one or more electronic devices 110-1 to 110-N with which the electronic device 110-0 has completed a connection or which are currently proceeding with a connection procedure. The connection status interface includes a step view 600 including interface elements 601 to 605 corresponding to sub-steps of the connection procedure. The interface elements 601 to 605 may include buttons.

The electronic device 110-0 uses the interface elements 601 to 605 to group and output the electronic devices 110-1 to 110-N which are on the same sub-step of the connection procedure. That is, if any one of the interface elements 601 to 605 is selected by a user, the electronic device 110-0 may display one of the electronic devices 110-1 to 110-N currently proceeding with a sub-step corresponding to the selected item. For example, if the interface element 605 corresponding to the perfect step is selected, the electronic device 110-0 displays a screen 610 showing a washer, a lamp, and a refrigerator which are on the perfect step of the connection procedure.

When one of the electronic devices 110-1 to 110-N fails to complete a specific sub-step and the connection procedure is interrupted, the electronic device 110-0 may display the sub-step at which the interruption occurred. For example, in case that the washer fails to complete a registration step, the registration step is displayed as the sub-step of the washer. Alternatively, in the case that one of the electronic devices 110-1 to 110-N fails to complete a specific sub-step and the connection procedure is interrupted, the electronic device 110-0 may display the last completed sub-step. For example, in case that the washer fails to complete the registration step, the preceding authentication step is displayed as the sub-step of the washer.

The connection status interface includes an interface element capable of, in case that one of the electronic devices 110-1 to 110-N fails to complete a specific sub-step and the connection procedure is interrupted, triggering the non-completed step to be resumed. For example, the electronic device 110-0 includes an interface element (e.g., a button) for triggering a corresponding sub-step in the screen 610. In addition, the electronic device 110-N may further provide information describing, for example, the cause (e.g., power supply interruption, wireless signal loss, etc.) of a non-completed sub-step, and/or measures to be taken (e.g., reboot, external technology support request, etc.) for the non-completed sub-step. In accordance with this, a user may take appropriate measures corresponding to the non-completed sub-step, thereby enabling the user to proceed with the connection procedure.

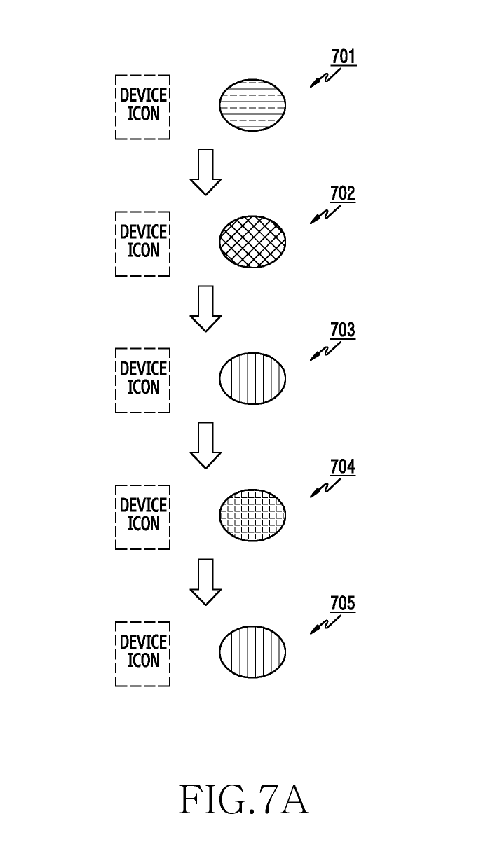

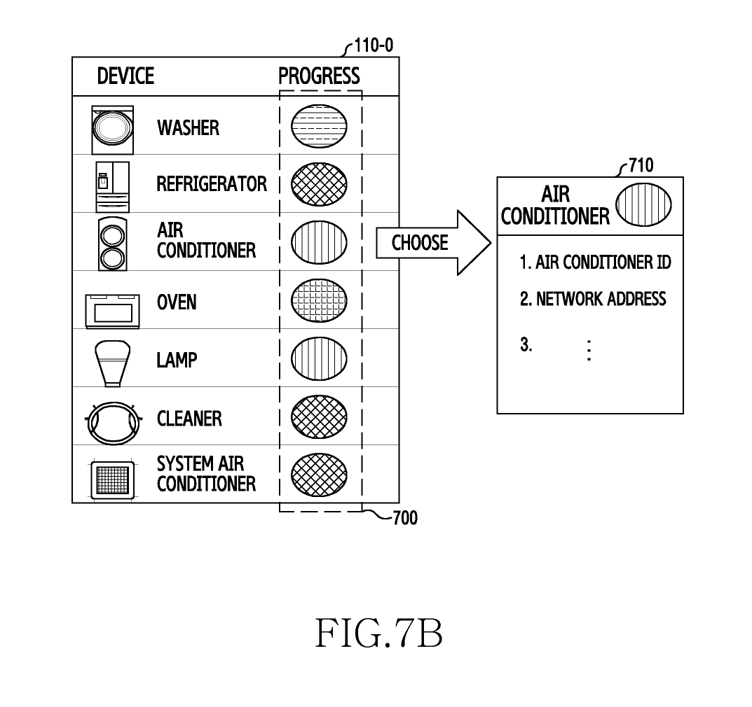

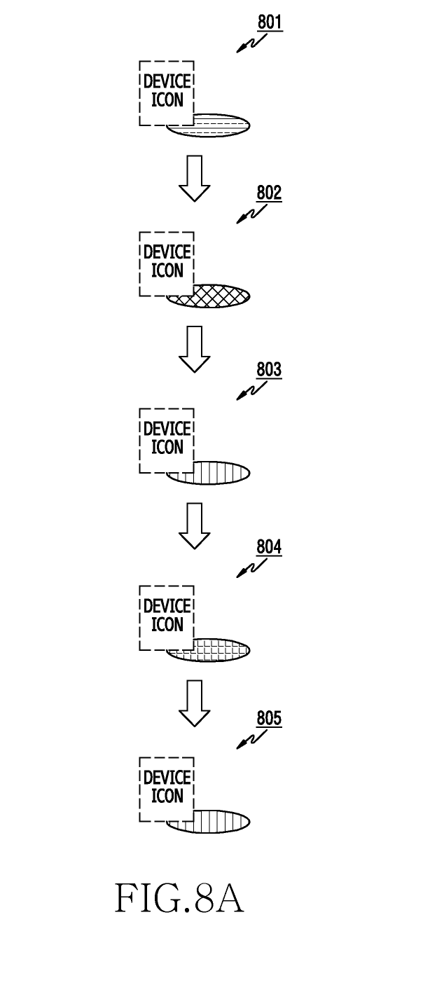

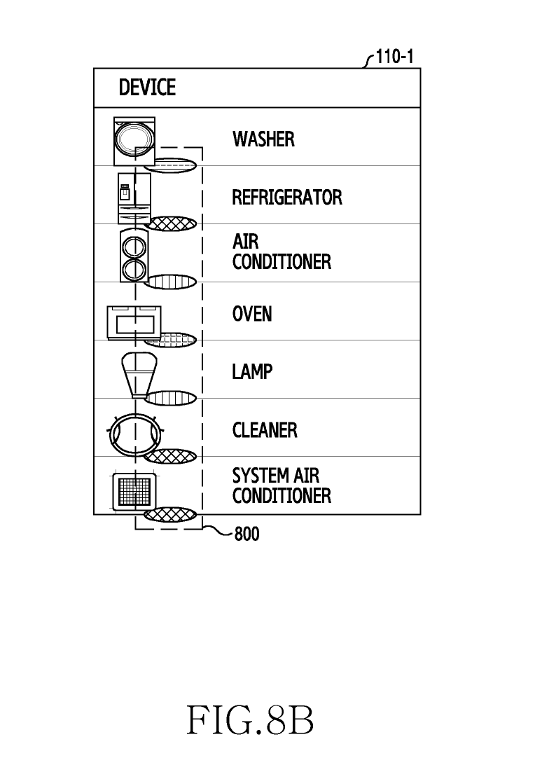

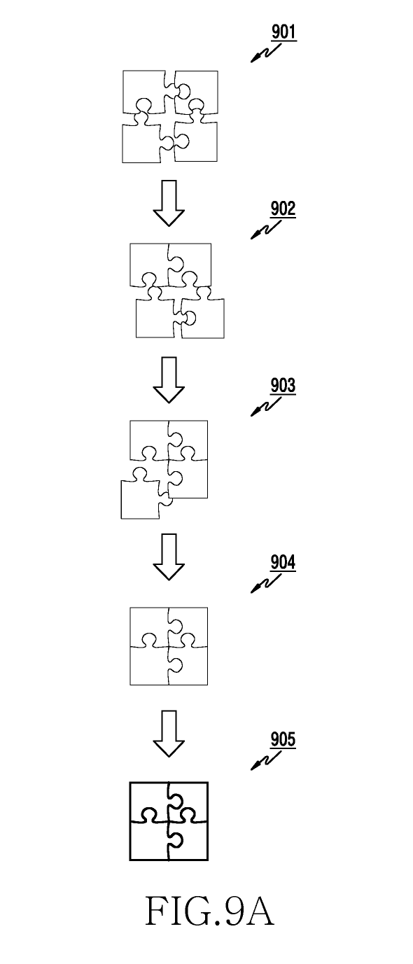

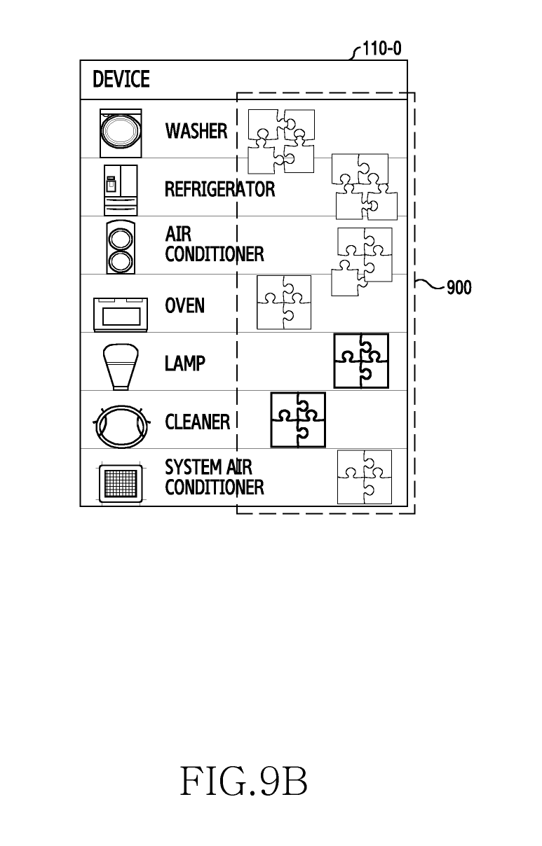

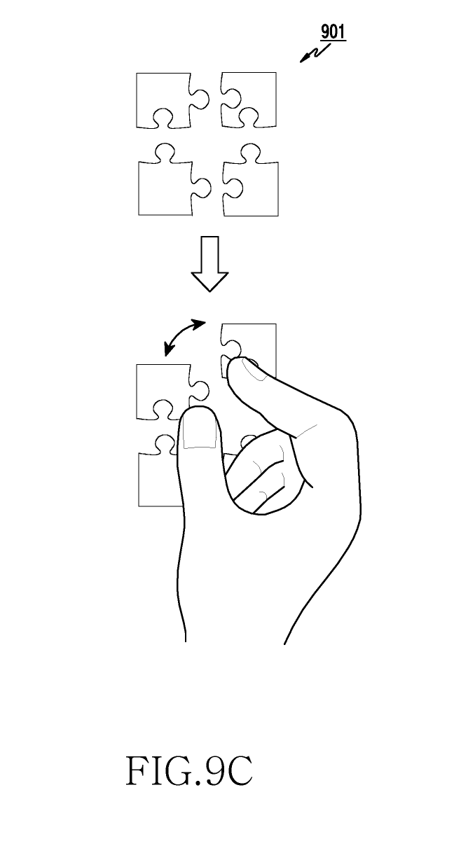

FIGS. 7A and 7B illustrate interface elements and an interface for displaying a connection status in an electronic device, according to embodiment of the present disclosure. FIGS. 8A and 8B illustrate interface elements and an interface for displaying a connection status in an electronic device, according to another embodiment of the present disclosure. FIGS. 9A to 9C illustrate interface elements and an interface for displaying a connection status in an electronic device, according to another embodiment of the present disclosure

Referring to FIGS. 7A-7B, 8A-8B, and 9A-9C, various methods of displaying interface elements on corresponding connection status interfaces are provided.

Referring to FIGS. 7A and 7B, a method of displaying a connection status of one of the electronic devices 110-1 to 110-N connectable with the electronic device 110-0, according to an embodiment of the present disclosure, is provided.

Referring to FIG. 7A, interface elements 701 to 705 may be used to show the connection status of one of the electronic devices 110-1 to 110-N. That is, one of the interface elements 701 to 705 is displayed at the right side of a device icon, representing one of the electronic devices 110-1 to 110-N connectable with an electronic device 110-0. The interface element which is displayed varies as the current sub-step of the connection procedure is changed. That is, as illustrated in FIG. 7A, the interface element is varied in order from interface elements 701 to 705. Interface element 701 displays a graphic pattern representing the initial discovery step, interface element 702 displays a graphic pattern representing the authentication step, interface element 703 displays a graphic pattern representing the registration step, interface element 704 displays a graphic pattern representing the service connection step, and interface element 705 displays a graphic pattern representing the perfect step.

Referring to FIG. 7B, electronic device 110-0 is shown displaying the connection status interface applying the connection status display scheme of FIG. 7A. The connection status interface includes icons of at least one of the electronic devices 110-1 to 110-N connected or in the process of being connected to the electronic device 110-0, and includes interface elements 700 showing the current sub-step of the respective electronic devices. That is, unlike the embodiment shown with respect to FIG. 6, in the embodiment shown with respect to FIG. 7B, a user may check a sub-step being in progress for each device without additional input.

When one of the device icons for the electronic devices 110-1 to 110N is selected by a user, the electronic device 110-0 displays a detailed information screen 710 for the selected one of the electronic devices 110-1 to 110N. The detailed information screen 710 shows the sub-step in progress for the selected one of the electronic devices 110-1 to 110N and supplementary information about the selected one of the electronic devices 110-1 to 110N. That is, the electronic device 110-0 displays, as procedure information, detailed information about a device for proceeding to a next sub-step from a current sub-step, through the detailed information screen 710. For example, if an in-progress sub-step of an air conditioner is a registration step and a corresponding interface element is selected, detailed information for proceeding to the next sub-step, i.e., a service connection step, is displayed. The detailed information includes device information acquired up to a previous sub-step. For example, the detailed information may include an IDentifier (ID) of the selected one of the electronic devices 110-1 to 110N, a network address, etc. The ID and the network address, which are unique identification information given to a home network domain, includes at least one of a Universal Unique ID (UUID), a Media Access Control (MAC) address, an IP address, and a node address, for example.

When the selected one of the electronic devices 110-1 to 110N fails to complete a specific sub-step and a connection procedure is interrupted, an interface element is displayed as the sub-step at which the interruption occurred. For example, in case that a washer fails to complete a registration step, the registration step is displayed as the sub-step of the washer. Alternatively, in the case that the selected one of the electronic devices 110-1 to 110N fails to complete a specific sub-step and the connection procedure is interrupted, the last completed sub-step is displayed as the sub-step of the washer. For example, in case that the washer fails to complete the registration step, the preceding authentication step is displayed as the sub-step of the washer.

The connection status interface includes an interface element capable of, in case that the selected one of the electronic devices 110-1 to 110N fails to complete a specific sub-step and the connection procedure is interrupted, triggering the non-completed step to be resumed. For example, the electronic device 110-0 includes an interface element (e.g., a button) for triggering a corresponding sub-step in the detail information screen 710. In addition, the electronic device 110-0 may further provide information describing, for example, the cause (e.g., power supply interruption, wireless signal loss, etc.) of the non-completed sub-step, and/or measures to be taken (e.g., reboot, external technology support request, etc.) for the non-completed sub-step. In accordance with this, a user may take appropriate measures corresponding to the non-completed sub-step, thereby enabling the user to proceed with the connection procedure.

Referring to FIGS. 8A and 8B, a method of displaying a connection status of one of the electronic devices 110-1 to 110-N connectable with the electronic device 110-0, according to another embodiment of the present disclosure, is provided.

Referring to FIG. 8A, interface elements 801 to 805 may be used to show the connection status of one of the electronic devices 110-1 to 110-N. That is, one of the interface elements 801 to 805 is displayed in a form of a shadow of a device icon representing one of the electronic devices 110-1 to 110-N. However, the interface elements 801 to 805, indicating the connection status, may be displayed in forms other than a shadow. The interface element which is displayed varies as the current sub-step of the connection procedure is changed. That is, as illustrated in FIG. 8A, the interface element is varied in order from interface elements 801 to 805. Interface element 801 displays a graphic pattern representing the initial discovery step, interface element 802 displays a graphic pattern representing the authentication step, interface element 803 displays a graphic pattern representing the registration step, interface element 804 displays a graphic pattern representing the service connection step, and interface element 805 displays a graphic pattern representing the perfect step

Referring to FIG. 8B, electronic device 110-0 is shown displaying the connection status interface applying the connection status display scheme of FIG. 8A. The connection status interface includes icons of at least one of the electronic devices 110-1 to 110-N connected on in the process of being connected to the electronic device 110-0, and includes interface elements 800 showing the current sub-step of the respective electronic devices.

Similar to the embodiment shown with respect to FIG. 7B, if any one of the electronic devices 110-1 to 110N is selected by a user, the electronic device 110-0 displays a detailed information screen for the selected one of the electronic devices 110-1 to 110N. The detailed information screen shows a sub-step in progress for the selected one of the electronic devices 110-1 to 110N and supplementary information about the selected one of the electronic devices 110-1 to 110N. Also, the connection status interface includes an interface element capable of triggering the non-completed sub-step to be resumed. For example, the electronic device 110-0 includes an interface element (e.g., a button) for triggering a corresponding sub-step in the detail information screen. In addition, the electronic device 110-0 may further provide information describing the cause (e.g., power supply interruption, wireless signal loss, etc.) of a non-completed sub-step.

Referring to FIGS. 9A to 9C a method of displaying a connection status of one of the electronic devices 110-1 to 110N connectable with the electronic device 110-0 using a combination of figures is provided.

Referring to FIG. 9A, interface elements 901 to 905 may be used to show the connection status of one of the electronic devices 110-1 to 110-N. The interface elements 901 to 905 are each composed of a plurality of figures. The connection status is identified by the number of and the order in which the plurality of figures are combined. As shown in FIG. 9A, the figures of each of the interface elements 901 to 905 are provided in a shape of a piece of a jigsaw puzzle. However, the shape of each figure may be defined differently. The interface element which is displayed varies as the current sub-step of the connection procedure is changed. That is, as illustrated in FIG. 9A, the interface element is varied in order from interface elements 901 to 905. In detail, interface element 901 represents the discovery step expressed in a state in which the figures are all not combined, interface element 902 represents the authentication step expressed in a state in which only the first and second figures are combined with each other, interface element 903 represents the registration step expressed in a state in which the first, second, and third figures are all combined with one another, interface element 904 represents the service connection step expressed in a state in which four figures are all combined with one another, and interface element 905 represents the perfect step expressed in a state in which four figures are all combined with one another. The interface element 904 and the interface element 905 are expressed in the same figure combination state, but may be distinguished by elements other than the combination state, such as a definition of a graphic, a brightness thereof, a color thereof, addition/deletion of other graphic elements, etc.

Referring to FIG. 9B, electronic device 110-0 is shown displaying the connection status interface applying the connection status display scheme of FIG. 9A. The connection status interface includes icons of at least one of the electronic devices 110-1 to 110-N connected on in the process of being connected to the electronic device 110-0, and includes interface elements 900 showing the current sub-step of the respective devices. In FIG. 9B, a washer is proceeding with the discovery step, a refrigerator is proceeding with the authentication step, an air conditioner is proceeding with the registration step, an oven and a system air conditioner are proceeding with the service connection step, and a lamp and a cleaner are proceeding with the perfect step.

Similar to the embodiment shown with respect to FIG. 7B, if any one of the electronic devices 110-1 to 110N is selected by a user, the electronic device 110-0 displays a detailed information screen for the selected of the electronic devices 110-1 to 110N. The detailed information screen shows a sub-step in progress for the selected of the electronic devices 110-1 to 110N and supplementary information about the selected of the electronic devices 110-1 to 110N. Also, the connection status interface includes an interface element capable of triggering the non-completed step to be resumed. For example, the electronic device 110-0 includes an interface element (e.g., a button) for triggering a corresponding sub-step in the detail information screen. In addition, the electronic device 110-0 may further provide information describing the cause (e.g., power supply interruption, wireless signal loss, etc.) of the non-completed step. Additionally, a triggering request may be input through the interface element showing the connection status.

Referring to FIG. 9C, a progress for triggering a sub-step of a connection procedure through the connection status interface of FIG. 9A is provided. FIG. 9C illustrates the interface element 901 and a case of triggering the discovery step. That is, as shown, the interface element 901 displays the discovery step as a state in which none of the figures are combined. A user may input the triggering request for completion of the discovery step by dragging two figures of the interface element 901 in different directions such that the two figures become distant from each other, in other words, by increasing a distance between the two figures. Thus, the triggering request is defined as increasing a distance between two figures combined at completion of a corresponding step.

The various embodiments of the present disclosure described thus far provide information about a connection status between an electronic device 110-0 and electronic devices 110-1 to 110-N participating in a connection setup with the electronic device 110-0, without participation or interaction of any other external devices. However, other embodiments of the present disclosure may use interaction with other external electronic devices not taking part in the connection setup, in determining the connection status, displaying the connection status, or generating information related to the connection status.

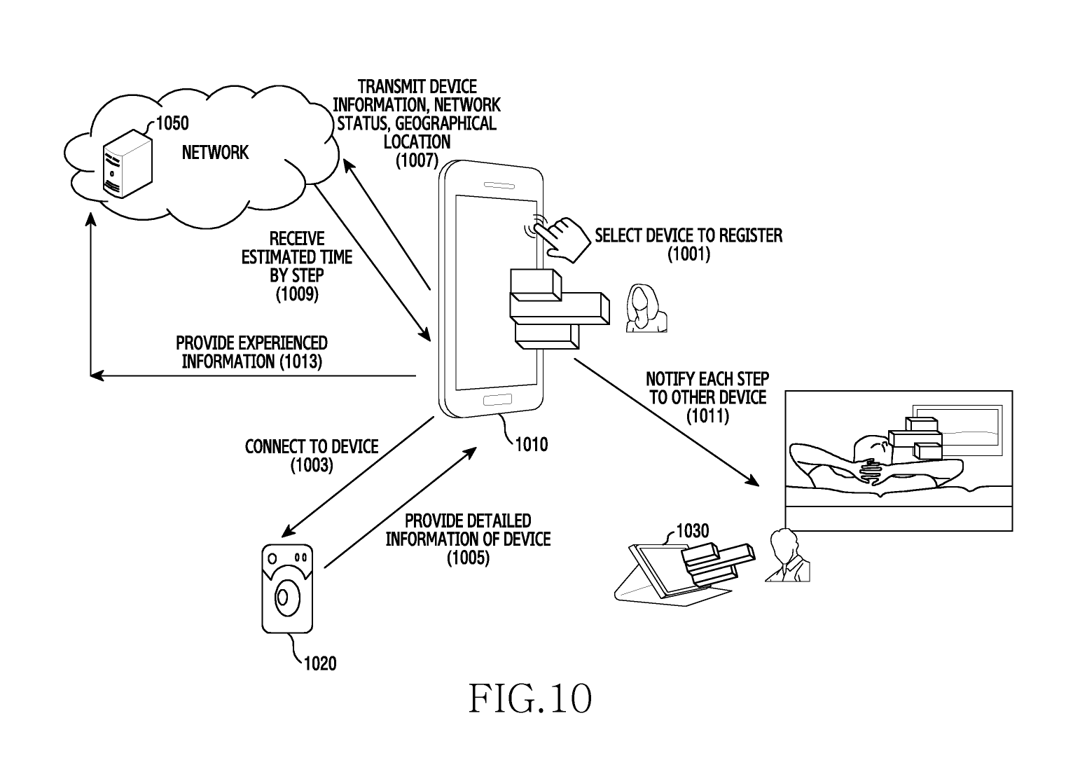

FIG. 10 illustrates a procedure for displaying a connection status in an electronic device, according to an embodiment of the present disclosure.

Referring to FIG. 10, a procedure of an electronic device 1010 for receiving an estimated time for each sub-step of a connection procedure, from a server 1050 existing in an external network, and displaying information about the connection status, through an external device 1020, is provided.

In step 1001, the electronic device 1010 detects a user's selection of a device to register. For example, a user may select an external device 1020 to set up a connection with the electronic device 1010, and the electronic device 1010 identifies the external device 1020 selected by the user.

In step 1003, the electronic device 1010 connects to the external device 1020. In detail, the electronic device 1010 sends the external device 1020 a request for information necessary for a service connection. The electronic device 1010 is in a state in which data exchange with the external device 1020 is available. That is, prior to a start of the present procedure, the electronic device 1010 and the external device 1020 are in a state of completing a connection of a lower layer for data exchange. However, step 1003 may additionally include a connection process of the lower layer.

In step 1005, the external device 1020 provides detailed information of the external device 1020 to the electronic device 1010. For example, the detailed information includes information necessary for a subsequent connection procedure, or supplementary information about the external device 1020. In detail, the detailed information may include identification information of the device, a network ID, manufacturing company information, user information, etc.

In step 1007, the electronic device 1010 provides information necessary for an estimated time determination to a server 1050 existing in an external network. The server 1050 may be a cloud server. The information necessary for the estimated time determination may include at least one of information of the external device 1020, information about the electronic device 1010, a network status, a geographical location of the external device 1020, and a geographical location of the electronic device 1010. The information of the external device 1020 may include all or some of the information of step 1005. The network status may include a channel quality between the electronic device 1010 and the external device 1020, a network type, etc.

In step 1009, the server 1050 provides an estimated time by sub-step of a connection procedure, to the electronic device 1010. That is, on the basis of the information of step 1007, the server 1050 determines an estimated time of each of the sub-steps of the connection procedure between the electronic device 1010 and the external device 1020. For this, the server 1050 may possess information about a history and statistics of performance times of sub-steps based on past connection procedures for at least one of the electronic device 1010 and the external device 1020.

In step 1011, the electronic device 1010 may notify a second electronic device 1030 of the progress of each sub-step. That is, the electronic device 1010 performs a connection procedure with the external device 1020, and displays information about the sub-steps of the connection procedure. Concurrently, the electronic device 1010 may notify the second electronic device 1030 of progress information for each sub-step, so that a user may observe the connection procedure through the second electronic device 1030, for example, through a device (e.g., a TV and a monitor) with a bigger display means. The electronic device 1010 may display the sub-steps using a 3-Dimensional (3D) image in, for example, a bar form.

In step 1013, the electronic device 1010 provides connection-related information to the server 1050. That is, after completing the connection procedure with the external device 1020, the electronic device 1010 provides to the server 1050, a result of the actual performance time for each sub-step of the connection procedure. According to this, the server 1050 may update the information about the history and statistics of the connection procedure between the electronic device 1010 and the external device 1020.

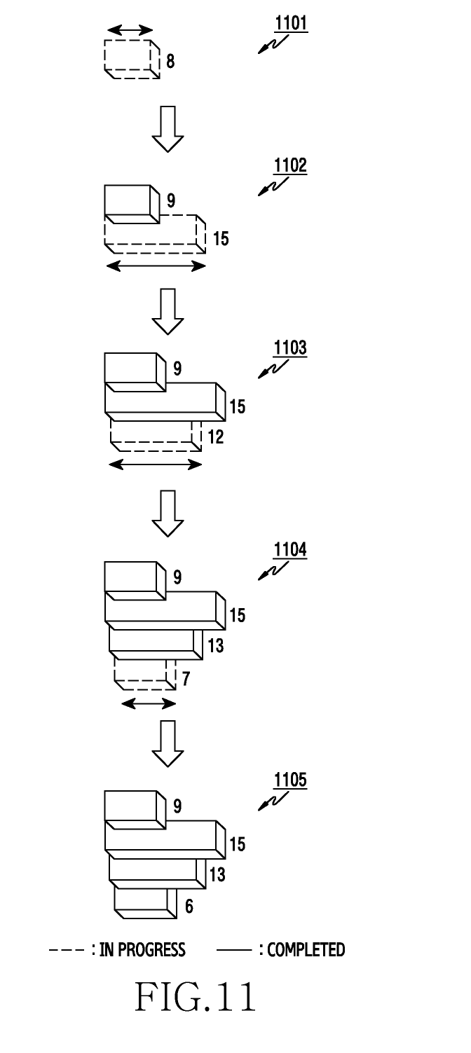

FIG. 11 illustrates an interface element for displaying a connection status in an electronic device, according to an embodiment of the present disclosure.

Referring to FIG. 11, interface elements 1101 to 1105 are provided. The interface elements 1101 to 1105 are composed of a plurality of 3D rectangular bars. Each sub-step of a connection procedure corresponds to one of the rectangular bars. The outline of the rectangular bars may be expressed with a dotted line or a solid line. The dotted line indicates that a corresponding step is in progress, and the solid line indicates that the corresponding step has been completed. Interface element 1101 represents the discovery step expressed as a single first rectangular bar outlined with a dotted line. Interface element 1102 represents the authentication step expressed as two rectangular bars, including a first rectangular bar, outlined with a solid line and a second rectangular bar, outlined with a dotted line. Interface element 1103 represents the registration step expressed as three rectangular bars, including the first rectangular bar, a second rectangular bar, outlined with a solid line, and a third rectangular bar, outlined with a dotted line. Interface element 1104 represents the service connection step expressed as four rectangular bars, including the first rectangular bar, the second rectangular bar, a third rectangular bar, outlined with a solid line, and a fourth rectangular bar, outlined with a dotted line. Interface element 1105 represents the perfect step expressed as four rectangular bars, including the first rectangular bar, the second rectangular bar, the third rectangular bar, and a fourth rectangular bar, outlined with a solid line. That is, the interface element 1105 representing the perfect step, displays all the rectangular bars outlined with solid lines. Graphics showing the sides of the four rectangular bars may be all the same, or may be displayed differently, for example in different colors or different patterns.

When the connection status display scheme illustrated in FIG. 11 is applied to the procedure of FIG. 10, an estimated time and an actual performance time may be displayed together. Referring to FIG. 11, a numeral is displayed at an end of each rectangular bar. The numeral represents the either the estimated time or the actual time. The time unit of the numeral may be differently defined in accordance with a configuration setting or a setting of a user. If a sub-step corresponding to a rectangular bar is in progress, i.e., if the rectangular bar is outlined with a dotted line, the numeral displayed at the end of the rectangular bar indicates the estimated time. In contrast, if the sub-step corresponding to the rectangular bar is completed, i.e., if the rectangular bar is outlined with a solid line, the numeral displayed at the end of the rectangular bar indicates the actual time. For example, as shown in FIG. 11, an estimated time of the discovery step, as shown by interface element 1101, is equal to 8, while the actual time thereof is equal to 9, as shown by interface element 1102 displayed after the discovery step is completed. An estimated time of the authentication step, as shown by interface element 1102, is equal to 15 and the actual time thereof is the same, as shown by interface element 1103 displayed after the authentication step is completed. An estimated time of the registration step, as shown by interface element 1103, is equal to 12, while the actual time thereof is equal to 13, as shown by interface element 1104 after displayed after the registration step is completed. An estimated time of the service connection step, as shown by interface element 1104, is equal to 7, while the actual time thereof is equal to 6, as illustrated by interface element 1105 displayed after the service connection step is completed.

As shown in FIG. 11, to display each sub-step, an image of a rectangular bar is used. However, an image of another form may be used. For example, a circular or polygonal image may be used. Also, a two-dimensional image may be used.

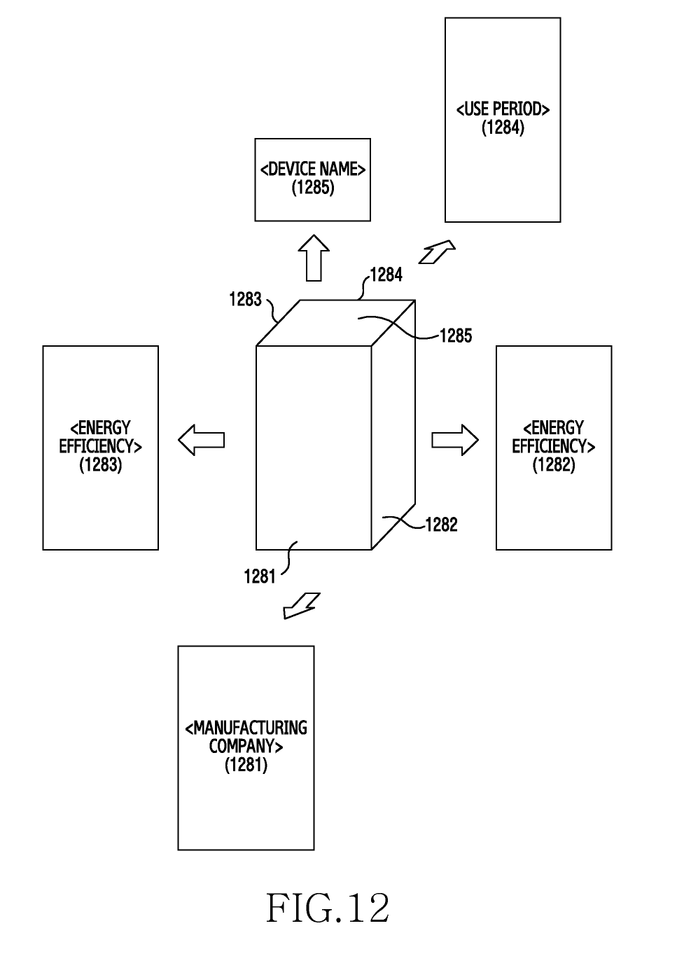

FIG. 12 illustrates a method of displaying supplementary information displayed through an interface element for displaying a connection status in an electronic device, according to an embodiment of the present disclosure.

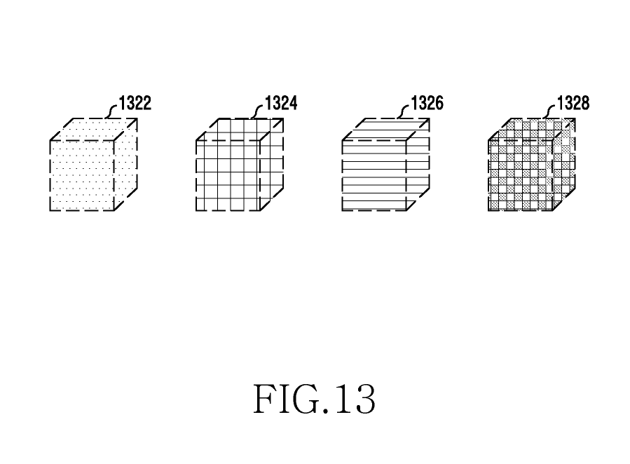

Referring to FIG. 12, the interface element of FIG. 11, implemented as a plurality of 3D rectangular bars, is provided. The 3D image of a rectangular bar has six sides. The 3D rectangular bar, shown in FIG. 12, has top side 1285, which is rendered to advance to a screen of the electronic device 110-0. Therefore, a bottom side is not visible to a user, but a front side 1281, a right side 1282, a left side 1283, a back side 1284, and the top side 1285 is visible to the user. Accordingly, the electronic device 110-0 provides supplementary information using the front side 1281, the right side 1282, the left side 1283, the back side 1284, and the top side 1285 visible to the user. The type of the supplementary information may be defined according to a configuration setting or a setting by a user. As shown in FIG. 12, information about a manufacturing company is displayed through the front side 1281, a manufacturing date is displayed through the right side 1282, energy efficiency information is displayed through the left side 1283, a use period is displayed through the back side 1284, and a device name is displayed through the top side 1285. However, the corresponding relationship between each side of the rectangular bar and the displayed supplementary information may be different. FIG. 13 illustrates a method of displaying supplementary information through an interface element for displaying a connection status in an electronic device, according to another embodiment of the present disclosure.

Referring to FIG. 13, 3D rectangular bars 1322, 1324, 1326, and 1328 are provided in different graphic patterns for representing different supplementary information. That is, unlike the embodiment shown with respect to FIG. 12, in FIG. 13, the supplementary information is not directly expressed, but indirectly expressed using a graphic pattern. In this case, a corresponding relationship between the graphic pattern and the content of the supplementary information may be previously defined. A user may figure out the content of the supplementary information as previously defined.

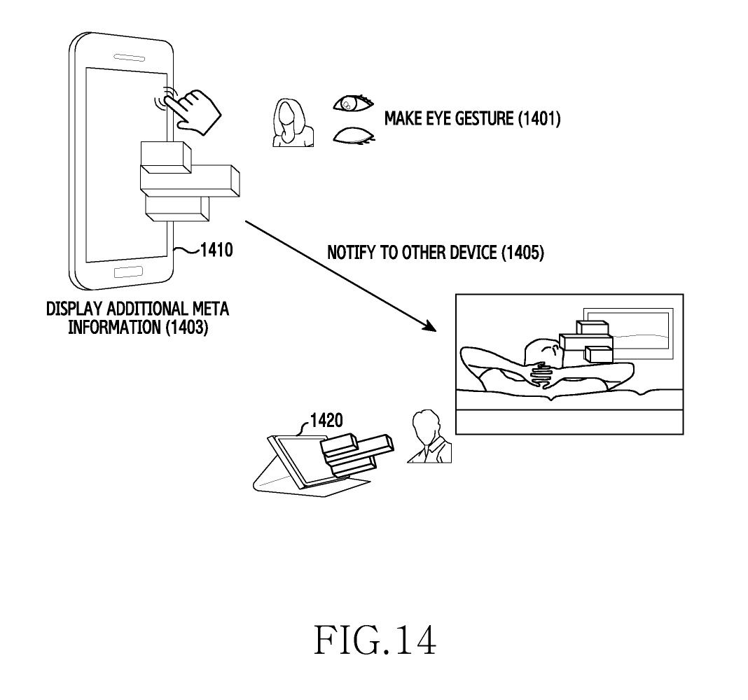

FIG. 14 illustrates a procedure for displaying supplementary information in an electronic device, according to an embodiment of the present disclosure.

Referring to FIG. 14, a procedure of an electronic device 1410 recognizing a supplementary information display request from a user and displaying the supplementary information through the electronic device 1410 and an external device 1420 is provided.

In step 1401, the electronic device 1410 detects an eye gesture made by a user. For example, the eye gesture may include eye blinking. The eye gesture is a motion defined as a supplementary information display request. The embodiment described with respect to FIG. 14 relates to eye blinking, but other gestures may be defined as the supplementary information display request. To recognize the eye gesture, the electronic device 1410 analyzes an image of a user's eye portion among an image inputted through a camera. In detail, the electronic device 1410 identifies a user's eye in the image, and analyzes an image change pattern corresponding to the eye blinking, thereby determining the eye blinking.

In step 1403, the electronic device 1410 displays additional meta information. That is, the electronic device 1410 displays supplementary information. The supplementary information includes at least one of manufacturing company information, a manufacturing date, a device name, a use period, and energy efficiency information. The electronic device 1410 may display the supplementary information in a region separated from an interface element displaying a connection status. Alternatively, as illustrated in FIG. 12, the electronic device 1410 may display the supplementary information on the sides of the 3D rectangular bars of the interface element displaying the connection status.

In step 1405, the electronic device 1410 may notify the external device 1420 of the supplementary information. For example, the external device 1420 may include a device (e.g., a TV, a monitor) with a display means bigger than that of the electronic device 1410. Accordingly, the external device 1420 displays the supplementary information, and the user may view the supplementary information through the external device 1420. In addition to the supplementary information, information about the connection status may be provided together.

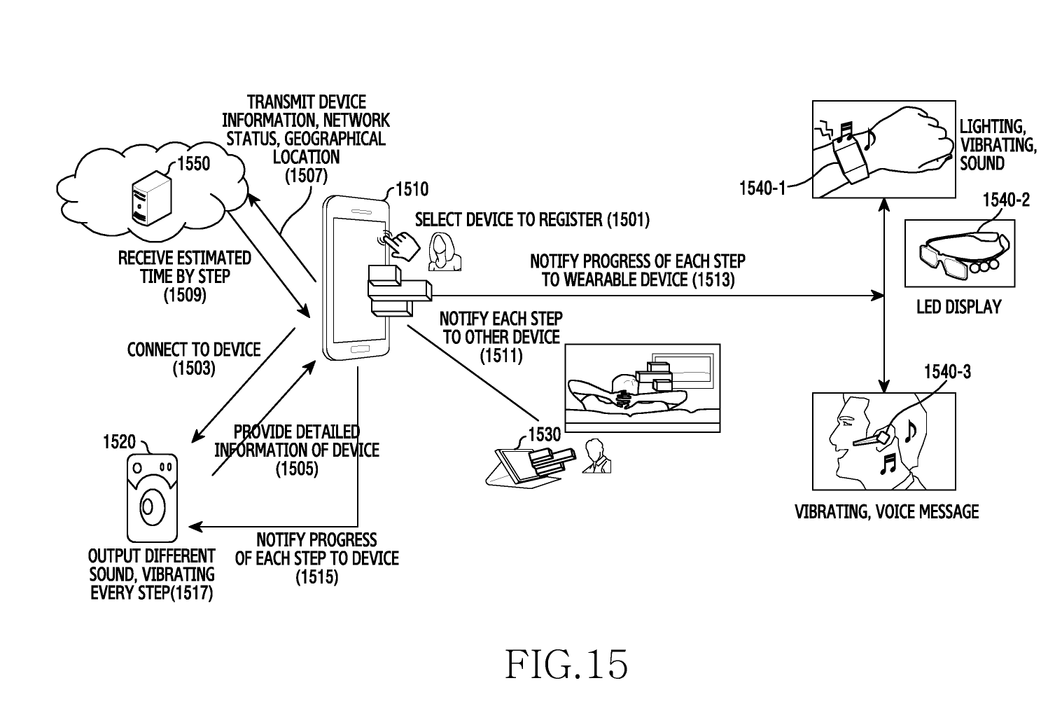

FIG. 15 illustrates a procedure for displaying a connection status in an electronic device, according to another embodiment of the present disclosure.

Referring to FIG. 15 a procedure is provided of an electronic device 1510 for receiving an estimated time for each sub-step of a connection procedure, from a server 1550 existing in an external network, and providing information about the connection status through various paths using an external device 1520 in the process of connection setup, a second electronic device 1530, and/or at least one wearable device 1540.

In step 1501, the electronic device 1510 detects a user's selection of a device to register. For example, a user may select external device 1520 to set up a connection with the electronic device 1510, and the electronic device 1510 identifies the external device 1520 selected by the user.

In step 1503, the electronic device 1510 connects to the external device 1520. In detail, the electronic device 1510 sends the external device 1520 a request for information necessary for a service connection. The electronic device 1510 is in a state in which data exchange with the external device 1520 is available. That is, prior to a start of the present procedure, the electronic device 1510 and the external device 1520 are in a state of completing a connection of a lower layer for data exchange. However, step 1503 may additionally include a connection process of the lower layer.

In step 1505, the external device 1520 provides detailed information of the external device 1520 to the electronic device 1510. For example, the detailed information includes information necessary for a subsequent connection procedure, or supplementary information about the external device 1520. In detail, the detailed information includes identification information of the device, a network ID, manufacturing company information, user information, etc.

In step 1507, the electronic device 1510 provides information necessary for an estimated time determination to a server 1550 existing in an external network. For example, the information necessary for an estimated time determination includes at least one of information of the external device 1520, information about the electronic device 1510, a network status, a geographical location of the external device 1520, and a geographical location of the electronic device 1510. The information of the external device 1520 includes all or some of the information described in step 1505. The network status includes a channel quality between the electronic device 1510 and the external device 1520, a network type, etc.

In step 1509, the server 1550 provides an estimated time of a connection procedure by sub-step, to the electronic device 1510. That is, on the basis of the information of step 1507, the server 1550 determines an estimated time of each of the sub-steps of the connection procedure between the electronic device 1510 and the external device 1520. For this, the server 1550 may possess information about a history and statistics of actual performance times of the sub-steps of previous connection procedures for at least one of the electronic device 1510 and the external device 1520.

In step 1511, the electronic device 1510 notifies a second electronic device 1530 of the progress of each sub-step. That is, the electronic device 1510 performs a connection procedure with the external device 1520, and displays information about a sub-step of the connection procedure. Concurrently, the electronic device 1510 notifies the second electronic device 1530 of progress information of each sub-step, so that a user may observe the connection procedure through the second electronic device 1530, for example, through a device (e.g., a TV or a monitor) with a bigger display means. The electronic device 1510 displays the sub-step using, for example, a 3D image of a bar form.

In step 1513, the electronic device 1510 provides information about each sub-step to at least one wearable device 1540, such as first, second, and third wearable devices 1540-1, 1540-2, and 1540-3. Accordingly, the at least one wearable device 1540 may output the information about each sub-step using an inherent output means. For example, the first wearable device 1540-1, in the form of a watch, may output the information about the each sub-step in the form of lighting, vibrating, sound, etc., and the second wearable device 1540-2, in the form of glasses, may output the information about the each sub-step in the form of an LED display, and the third wearable device 1540-3, in the form of an earphone, may output the information about the each step in a form of vibrating or a voice message.

In step 1515, the electronic device 1510 notifies the external device 1520 of the progress of each step. The progress of each step is provided in real time. That is, the electronic device 1510 provides the information about each step to the external device 1520, whenever the sub-step of the connection procedure changes. However, because the external device 1520 joins the connection procedure, the external device 1520 may directly determine the connection status. Alternatively, step 1515 may be omitted.

In step 1517, the external device 1520 provides information about the connection status between the electronic device 1510 and the external device 1520 using an inherent output means. For example, the external device 1520 may output a sound corresponding to a sub-step in progress, or output a vibration of a pattern or strength corresponding to the sub-step in progress. Or, the other device 1520 may output a text, a numeral, an image, etc. corresponding to the sub-step in progress.

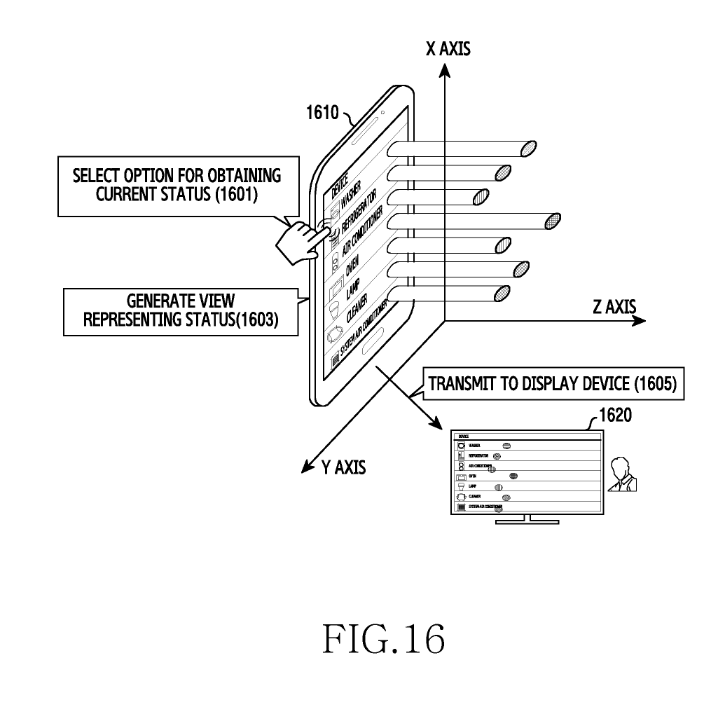

FIG. 16 illustrates a procedure for displaying a connection status in an electronic device, according to another embodiment of the present disclosure.

Referring to FIG. 16, a procedure of electronic device 1610 for displaying connection status information by device, in a list of a plurality of devices is provided.

In step 1601, electronic device 1610 detects an input for a user selection of an option for obtaining a current status of a connection procedure. For example, selecting the option may include the selecting of a menu for connection status display.

In step 1603, the electronic device 1610 generates an interface screen displaying a sub-step of a connection status between the electronic device 1610 and a plurality of devices. An interface element is displayed to show the connection status for each device. The interface element may be expressed in a different graphic pattern in based on the sub-step. In addition, the interface element may be expressed through a 3D image. The 3D image may be rendered to advance in a vertical direction of a display means of the electronic device 1610, i.e., in a Z-axis direction, as shown in FIG. 16, such that it is proportional to a degree of progress of the sub-step of the connection procedure.

In step 1605, the electronic device 1610 transmits information representing the connection status to display device 1620. Alternatively or additionally, the electronic device 1610 transmits image data of the interface screen to the display device 1620. Accordingly, the display device 1620 displays the information representing the connection status. The display device 1620 may display the connection status through a 3D image.

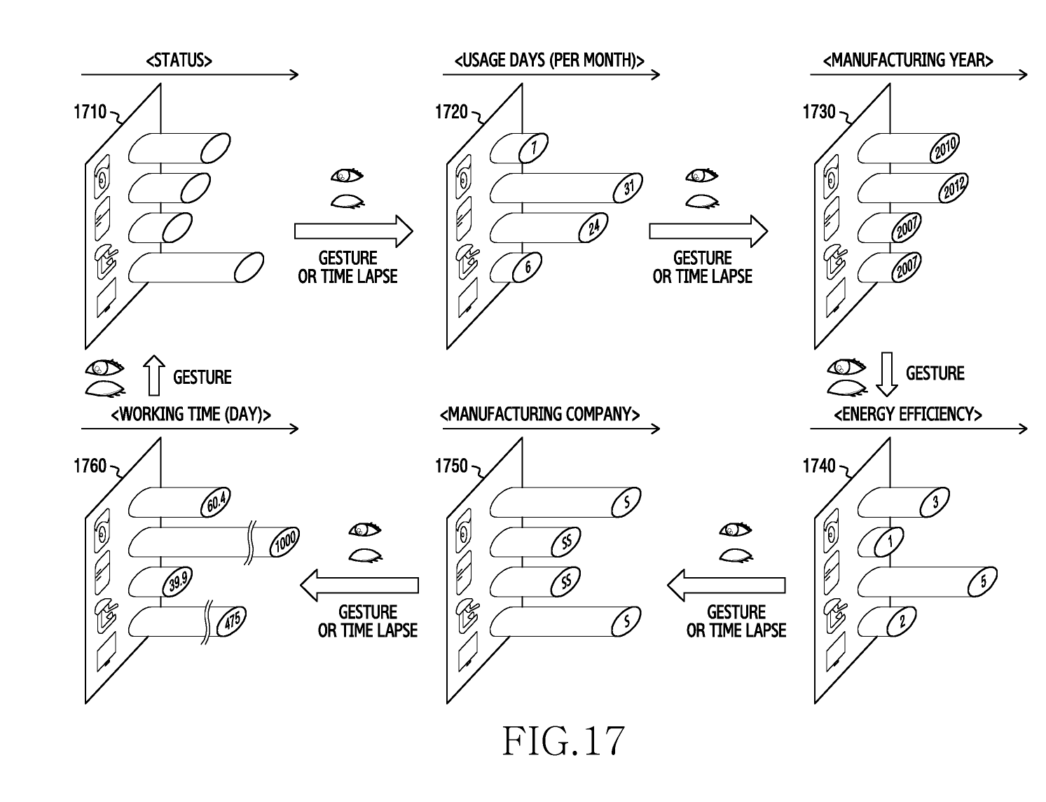

FIG. 17 illustrates a procedure for displaying supplementary information in an electronic device, according to another embodiment of the present disclosure.

Referring to FIG. 17, a procedure of electronic device 1610 for configuring a screen using 3D interface elements for displaying supplementary information and changing the type of the supplementary information displayed is provided.

A status screen 1710, a use period screen 1720, a manufacturing year screen 1730, an energy efficiency screen 1740, a manufacturing company screen 1750, and a mileage screen 1760 of the electronic device 1610 are shown. Conversion between the screens 1710 to 1760 is achieved in accordance with a user's gesture or time lapse. For example, the user gesture may include eye blinking. The kind and conversion order of the supplementary information displayed on the screens 1710 to 1760, illustrated in FIG. 17, are one example, and different supplementary information or a different conversion order may be applied.

The status screen 1710 displays connection statuses by device. The electronic device 1610 performs rendering such that an interface element showing a connection status of each device advances in a vertical direction of a display means of the electronic device 1610 in proportion to a degree of progress of the sub-step of the connection procedure. In addition to this, a graphic pattern corresponding to the sub-step of the connection procedure may be added to the interface element.

The usage days screen 1720 displays days of usage for a period of time, by device. For example, the usage days may be displayed, for example, by the unit of month. An interface element showing the use period of each device includes a numeral indicating the use period. Also, the electronic device 1610 may perform rendering such that a corresponding interface element advances in a vertical direction of a display means of the electronic device 1610 in proportion to a length of the usage days. In addition to this, a graphic pattern corresponding to a range including the usage days may be added to the interface element.

The manufacturing year screen 1730 displays a manufacturing year by device. An interface element showing a manufacturing year of each device includes a numeral indicating the manufacturing year. Also, the electronic device 1610 performs rendering such that a corresponding interface element advances in a vertical direction of a display means of the electronic device 1610 in proportion to a value of the manufacturing year. In addition to this, a graphic pattern corresponding to a range including the manufacturing year may be added to the interface element.

The energy efficiency screen 1740 displays an energy grade by device. An interface element showing an energy grade of each device includes a numeral indicating the energy grade. Also, the electronic device 1610 performs rendering such that a corresponding interface element advances in a vertical direction of a display means of the electronic device 1610 in proportion to a value of the energy grade. In addition to this, a graphic pattern corresponding to the energy grade may be added to the interface element.

The manufacturing company screen 1750 displays an identification of a manufacturing company by device. An interface element showing the identification of the manufacturing company of each device includes a Company Identity (CI) representing a corresponding manufacturing company, a manufacturing company name, a logo, etc. Also, the electronic device 1610 performs rendering such that a corresponding interface element advances in a vertical direction of a display means of the electronic device 1610 in proportion to a value of the manufacturing company identification. The value of the manufacturing company may be determined based on, information from websites, for example. In addition to this, a symbol, a numeral, or a graphic pattern representing the manufacturing company may be added to the interface element.

The working time screen 1760 displays working hours by device. For example, the working time may be displayed by the unit of day. An interface element showing a working time of each device includes a numeral indicating the corresponding working hours. Also, the electronic device 1610 performs rendering such that a corresponding interface element advances in a vertical direction of a display means of the electronic device 1610 in proportion to a value of the working hours. In addition to this, a graphic pattern corresponding to the working hours may be added to the interface element.

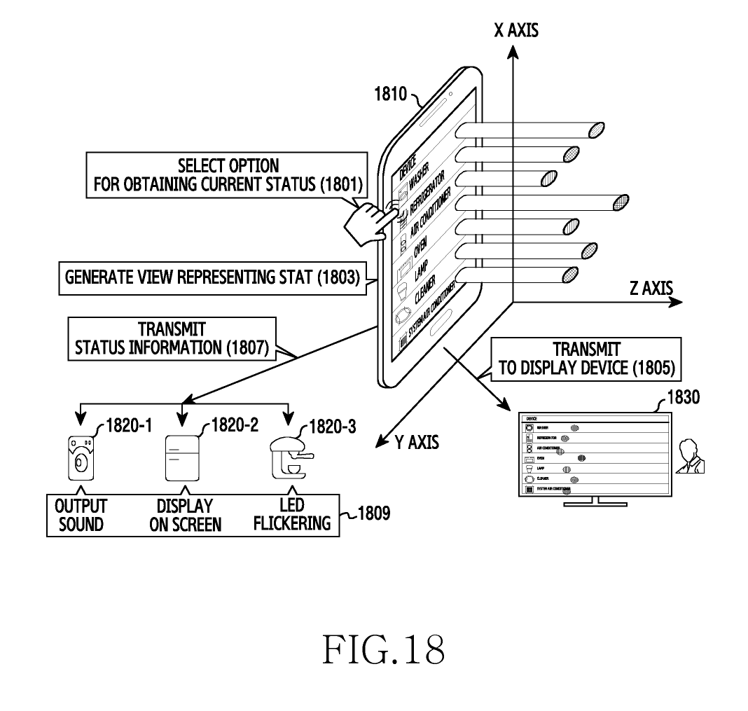

FIG. 18 illustrates a procedure of displaying a connection status in an electronic device, according to an embodiment of the present disclosure.

Referring to FIG. 18, a procedure of electronic device 1810 for displaying connection status information by device and transmitting connections status information of a device to the corresponding device for output is provided.

In step 1801, electronic device 1810 senses a user's input for selecting an option for obtaining a current status. Selecting the option may include selecting a menu for connection status display.

In step 1803, the electronic device 1810 generates an interface screen displaying a sub-step of a connection procedure with a plurality of other devices 1820-1 to 1820-3.

Interface elements showing a connection status by each device are displayed. The interface element may be expressed in a different graphic pattern based on the sub-step. In addition, the interface element is expressed through a 3D image. The 3D image is rendered to advance in a vertical direction of a display means of the electronic device 1810, i.e., in a Z-axis direction, as shown in FIG. 18, such that it is proportional to a degree of progress of a sub-step of a connection procedure.

In step 1805, the electronic device 1810 transmits information representing the connection status to a second electronic device 1830. Alternatively or additionally, the electronic device 1810 transmits image data of the interface screen to the second electronic device 1830. Accordingly, the second electronic device 1830 displays the information representing the connection status. The second electronic device 1830 displays the connection status through a 3D image.

In step 1807, the electronic device 1810 notifies the other devices 1820-1 to 1820-3 of the progress. The progress of each sub-step is provided in real time. That is, the electronic device 1810 provides the information about the each sub-step to the other devices 1820-1 to 1820-3 whenever the sub-step of the connection procedure changes. However, since the other devices 1820-1 to 1820-3 join the connection procedure, the other devices 1820-1 to 1820-3 may directly determine the connection status. Accordingly, step 1807 may be omitted.

In step 1809, the other devices 1820-1 to 1820-3 provide a notification of the progress using an inherent output means. For example, the first device 1820-1 may output a sound corresponding to a sub-step in progress, and the second device 1820-2 may display, on a screen, a character, a numeral, an image, etc. representing the sub-step in progress, and the third device 1820-3 may flicker an LED in a pattern corresponding to the sub-step in progress.

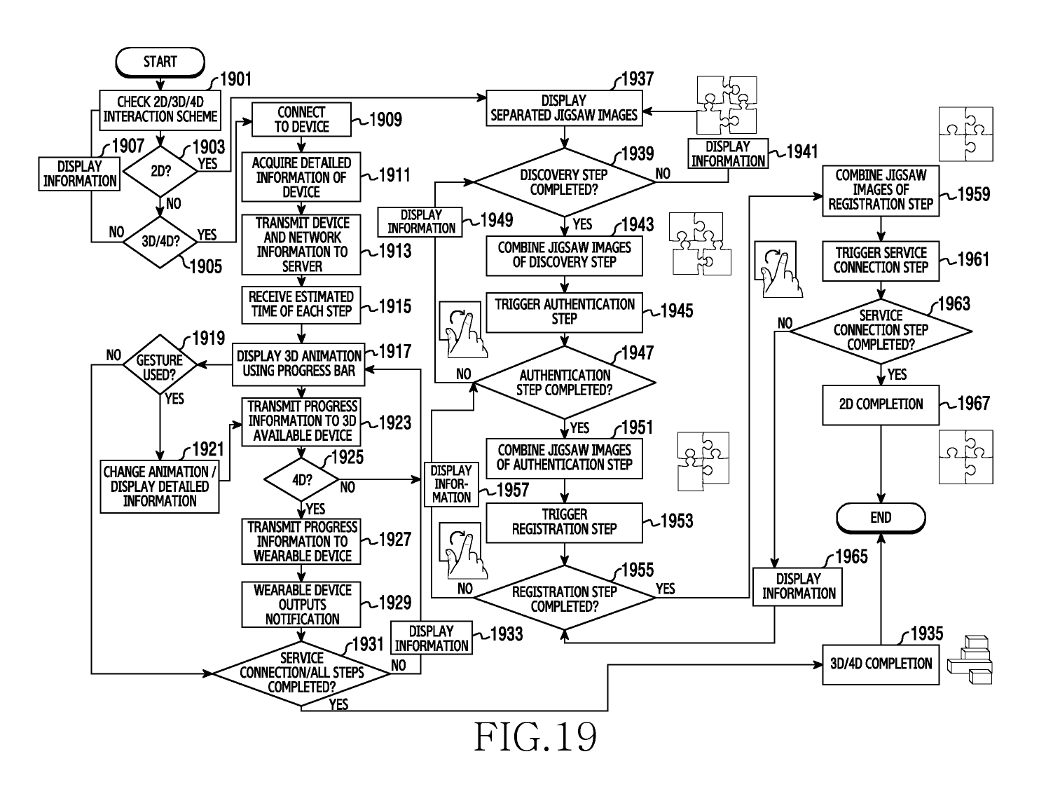

FIG. 19 is a flowchart of a procedure for displaying a connection status in an electronic device, according to an embodiment of the present disclosure.

Referring to FIG. 19, a procedure in which a 2-Dimensional (2D) scheme, a 3D scheme, and a 4-Dimensional (4D) scheme are selectively available is provided. The 2D scheme refers to scheme which uses a 2D image for the interface element, for example, a jigsaw puzzle image is used for the interface element. The 3D scheme refers to a scheme which uses a 3D image for the interface element, for example the 3D rectangular bar is used for the interface element. The 4D scheme refers to outputting additional information through a wearable device.

In step 1901, the electronic device 1510, as shown in FIG. 15, determines an interaction scheme to use among the 2D scheme, the 3D scheme, and the 4D scheme for displaying the connection status between the electronic device 1510 and an external device 1520. For example, the interaction scheme is determined by a selection of a user or a capability of the electronic device 1510.

The electronic device 1510 proceeds to step 1903 and determines if the 2D scheme is used. If the 2D scheme is not used, the electronic device 1510 proceeds to step 1905 and determines if the 3D scheme or 4D scheme is used. If the 3D scheme or the 4D scheme is not used, the electronic device 1510 proceeds to step 1907 and displays information indicating that the scheme for displaying the connection status is not determined. In addition, the electronic device 1510 displays information requesting to select the scheme for displaying the connection status.

If the 3D scheme or 4D scheme is used in step 1905, the electronic device 1510 proceeds to step 1909 and connects to the external device 1520. The electronic device 1510 proceeds to step 1911 and acquires detailed information of the external device 1520. For example, the detailed information includes information necessary for a subsequent connection procedure, or supplementary information about the external device 1520. In detail, the detailed information includes identification information of the device, a network ID, manufacturing company information, user information, etc. Next, the electronic device 1510 proceeds to step 1913 and transmit device and network information to server 1550. The electronic device 1510 proceeds to step 1915 and receives an estimated time of each sub-step from the server 1550. The electronic device 1510 proceeds to step 1917 and display a 3D animation using a progress bar. That is, the electronic device 1510 displays sub-steps of a connection procedure with the external device 1520 using a 3D image of a bar form.

The electronic device 1510 proceeds to step 1919 and determines if a gesture is used. The gesture is used as an instruction for requesting supplementary information or detailed information. For example, the gesture may include eye blinking. If the gesture is used in step 1919, the electronic device 1510 proceeds to step 1921 and changes the animation and displays detailed information. Alternatively or additionally, the electronic device 1510 displays supplementary information. Next, the electronic device 1510 proceeds to step 1923 and transmits progress information about a connection status to a second electronic device 1530 in which 3D expression is available. Accordingly, the second electronic device 1530 displays the information about the connection status.

The electronic device 1510 proceeds to step 1925 and determines if the 4D scheme is used. If the 4D scheme is used, the electronic device 1510 proceeds to step 1927 and transmits the progress information to at least one wearable device 1540. Accordingly, the at least one wearable device 1540 proceeds to step 1929 and outputs a notification received from the electronic device 1510, i.e., the information about the connection status, using an inherent output means. Thereafter, the electronic device 1510 proceeds to step 1931 and determines if service connection has been completed, i.e., all sub-steps have been completed. If the all sub-steps have not been completed, the electronic device 1510 proceeds to step 1933 and displays information about a current sub-step. In contrast, if the all sub-steps have been completed, the electronic device 1510 proceeds to step 1935 and determines the completion of connection status information provision using the 3D scheme or 4D scheme, and terminates the present procedure.

If the 2D scheme is used in step 1903, the electronic device 1510 proceeds to step 1937 and displays an interface element as an image of separated pieces of a jigsaw puzzle. That is, the electronic device 1510 displays the pieces of the jigsaw puzzle image in a non-combined state. Thereafter, the electronic device 1510 proceeds to step 1939 and determines if a discovery step has been completed. If the discovery step has not been completed, the electronic device 1510 proceeds to step 1941 and displays information about the discovery step. Based on a user's instruction, the electronic device 1510 may further display supplementary information. If the discovery step has been completed in step 1939, the electronic device 1510 proceeds to step 1943 and combines two of the pieces of the jigsaw puzzle image to represent the completion of the discovery step.

Thereafter, the electronic device 1510 proceeds to step 1945 and triggers an authentication step. A user's drag of the combined pieces of the jigsaw puzzle image may trigger the authentication step. Alternatively, because the discovery step has been completed, the authentication step may be triggered without a user's instruction and, in this case, the user's drag is omitted. Next, the electronic device 1510 proceeds to step 1947 and determines if the authentication step has been completed. If the authentication step has not been completed, the electronic device 1510 proceeds to step 1949 and displays information indicating that the authentication step has not been completed. Based on a user's instruction, the electronic device 1510 may further display supplementary information. If the authentication step has been completed, the electronic device 1510 proceeds to step 1951 and combines three of the pieces of the jigsaw puzzle image to represent the completion of the authentication step.

Next, the electronic device 1510 proceeds to step 1953 and triggers a registration step. A user's drag of the combined pieces of the jigsaw puzzle image may trigger the registration step. Alternatively, because the authentication step has been completed, the registration step may be triggered without a user's instruction and, in this case, the user's drag is omitted. Next, the electronic device 1510 proceeds to step 1955 and determines if the registration step has been completed. If the registration step has not been completed, the electronic device 1510 proceeds to step 1957 and displays information indicating that the registration step has not been completed. Based on a user's instruction, the electronic device 1510 may further display supplementary information. If the registration step has been completed, the electronic device 1510 proceeds to step 1959 and combines all four of the pieces of the jigsaw puzzle image to represent the completion of the registration step.

Thereafter, the electronic device 1510 proceeds to step 1961 and triggers a service connection step. A user's drag of the combined pieces of the jigsaw puzzle image may trigger the service connection step. Alternatively, because the registration step has been completed, the service connection step is triggered without a user's instruction and, in this case, the user's drag is omitted. Next, the electronic device 1510 proceeds to step 1963 and determines if the service connection step has been completed. If the service connection step has not been completed, the electronic device proceeds to step 1965 and display information indicating that the service connection step has not been completed. Based on a user's instruction, the electronic device 1510 may further display supplementary information. If the service connection step has been completed, the electronic device 1510 proceeds to step 1967 and determines the completion of connection status information provision using the 2D scheme, and may display the image of the jigsaw puzzle in the combined state differently than in the registration step, such as highlighted, in a different color, etc. The electronic device 1510 terminates the present procedure.

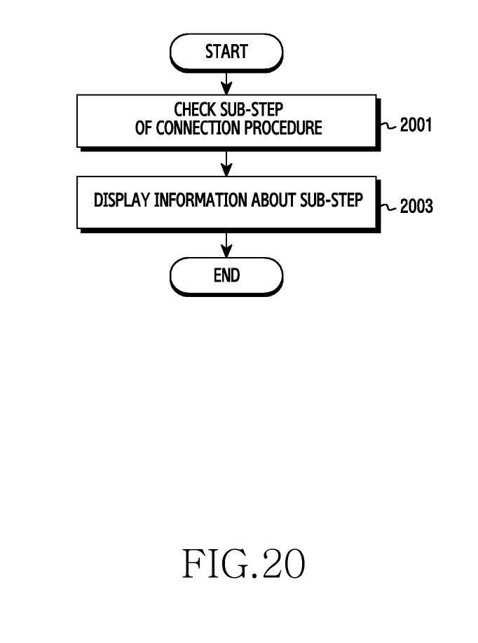

FIG. 20 is a flowchart of an operation procedure of an electronic device, according to an embodiment of the present disclosure.

Referring to FIG. 20, an operation method of the electronic device 1510, for displaying information about a connection status during execution of a connection procedure with at least one external electronic device 1520 is provided.

In step 2001, the electronic device 1510 determines a sub-step of the connection procedure with at least one external electronic device 1520. That is, the electronic device 1510 determines a current sub-step among a plurality of sub-steps included in the connection procedure with at least one external electronic device 1520. The electronic device 1510 determines at least one external electronic device 1520 belonging to a specific sub-step selected by a user, or determines a current sub-step of at least one external electronic device 1520 which is proceeding with the connection procedure.

Thereafter, the electronic device 1510 proceeds to step 2003 and displays information about the sub-step. That is, the electronic device 1510 displays an interface element showing the current sub-step. The sub-step may be expressed with at least one of a graphic pattern of the interface element, a color of the interface element, a combination state of figures constructing the interface element, and a height or length of a 3D rendering object constructing the interface element.

Though not illustrated in FIG. 20, the electronic device 1510 may further display supplementary information about the at least one external electronic device 1520, in addition to the information about the sub-step. For example, the supplementary information is displayed by the user selecting of one external electronic device 1520. The supplementary information may be displayed through a pop-up window. Or, in case that the sub-step is expressed using a 3D rendering object, the supplementary information may be displayed on at least one of the sides of the 3D rendering object. Or, the supplementary information may be displayed using the 3D rendering object. In this case, the 3D rendering object having a height or length proportional to a value of the supplementary information is displayed. After the supplementary information is displayed, the electronic device 1510 may sequentially display supplementary information of different content in accordance with a user's predefined instruction. The user's instruction may be defined as a gesture (e.g., eye blinking).

Also, though not illustrated in FIG. 20, the electronic device 1510 may transmit image data displaying the information about the sub-step, to the at least one external device 1520. In this case, the at least one external device 1520 outputs the information about the sub-step through an inherent output means. Also, the electronic device 1510 may transmit the information about the sub-step or the image data displaying the information about the sub-step, to a second electronic device 1530 which is not part of the connection procedure. For example, the second electronic device 1530 may be a device having a display means bigger than that of the electronic device 1510. Or, the second electronic device 1530 may be a wearable device 1540. Accordingly, the second electronic device 1530 may output the information about the sub-step, and the information about the sub-step may be outputted to a user in various schemes.

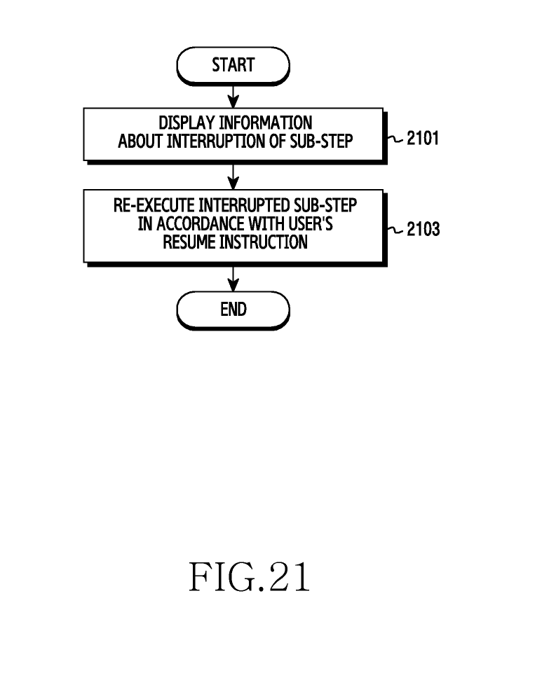

FIG. 21 is a flowchart of an operation procedure of an electronic device, according to another embodiment of the present disclosure.

Referring to FIG. 21 an operation method of the electronic device 1510 for displaying information about an interruption in a connection procedure is provided.

In step 2101, the electronic device 1510 displays the cause of interruption of an interrupted sub-step. For example, the interruption cause may include power supply interruption, wireless signal loss, etc. The interruption cause is displayed when the external electronic device 1520 is selected by a user, or may be displayed together with information notifying the interruption. Together with the interruption cause, supplementary information about the external electronic device 1520 may be displayed together.

Thereafter, the electronic device 1510 proceeds to step 2103 and senses a user's instruction of requesting the re-execution of the interrupted sub-step, and re-executes the interrupted sub-step. That is, the electronic device 1510 displays an interface element for requesting the re-execution of the sub-step. For example, the interface element may include a button. Or, in case that the sub-step is expressed by a combination state of a plurality of figures, the request for the re-execution of the sub-step is instructed by dragging in different directions two figures combined due to the completion of the corresponding sub-step, such that the two figures become distant away from each other.

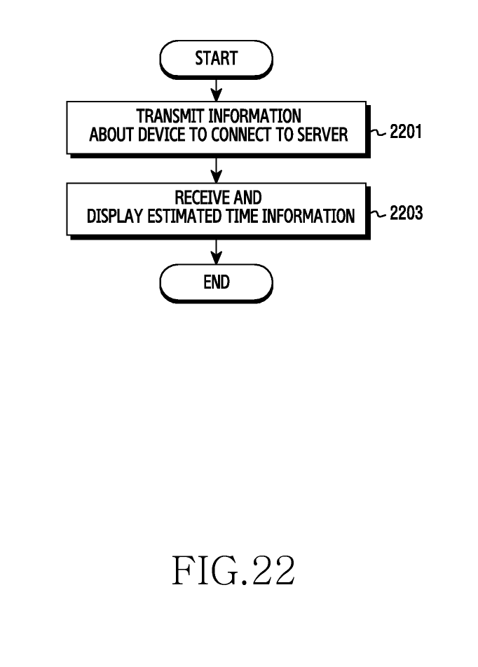

FIG. 22 is a flowchart of an operation procedure of an electronic device, according to another embodiment of the present disclosure.

Referring to FIG. 22, an operation method of an electronic device 1510 for displaying an estimated time for execution of a connection procedure is provided.

In step 2201, the electronic device 1510 transmits information about external electronic device 1520, to a server 1550. The server 1550 may exist in an external network. For example, the server may be a cloud server. For example, the information about the external electronic device 1520 includes at least one of identification information of the external electronic device 1520, a network status, and a geographical location of the external electronic device 1520. In addition, the electronic device 1520 may transmit information about the electronic device 1510, together.

Thereafter, the electronic device 1510 proceeds to step 2203 and receives an estimated time for each sub-step of a connection procedure, from the server 1520. And, the electronic device 1510 displays the estimated time. For example, the estimated time is displayed together with information about the each sub-step. The electronic device 1510 may display the estimated time at the time of the start of each sub-step, together.

Though not illustrated in FIG. 22, after the completion of each sub-step, the electronic device 1510 may transmit an actual time for performing a corresponding sub-step to the server 1550. Accordingly, the server 1550 may update the information about the estimated time using information experienced by the electronic device 1510.

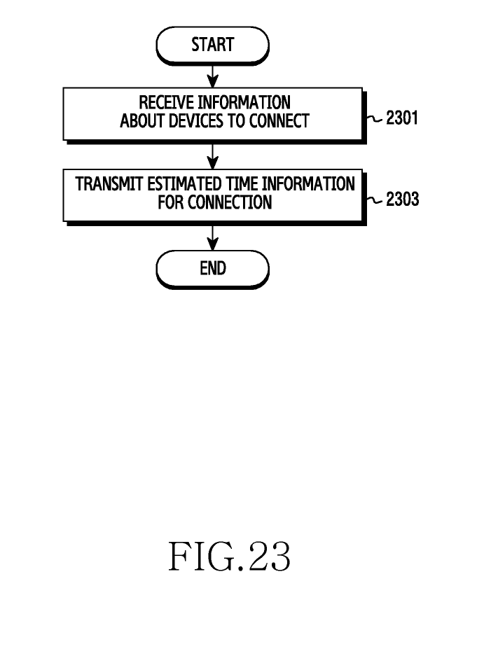

FIG. 23 is a flowchart of an operation procedure of a server managing information about a connection procedure, according to an embodiment of the present disclosure.

Referring to FIG. 23, an operation method of the electronic device 1510 for providing an estimated time for each sub-step of the connection procedure in the server 1550 is provided.

In step 2301, the server 1550 receives information about external electronic device, from the electronic device 1510. For example, the information about the external electronic device 1520 includes at least one of identification information of the external electronic device 1520, a network status, and a geographical location of the external electronic device 1520. In addition, the server 1550 may receive information about the electronic device 1510, together.

Thereafter, the server 1550 proceeds to step 2303 and transmits an estimated time for each sub-step of a connection procedure, to the electronic device 1510. That is, the server 1550 may possess information about a history and statistics of actual performance times for sub-steps of previous connection procedures performed between the electronic device 1510 and the external electronic device 1520. Accordingly, on the basis of the received information of step 2301, the server 1550 determines and provides the estimated time.

Though not illustrated in FIG. 23, the server 1550 may receive an actual time for performing each sub-step from the electronic device 1510. Accordingly, the server 1550 may update the information about the history and statistics using information experienced by the electronic device 1510.

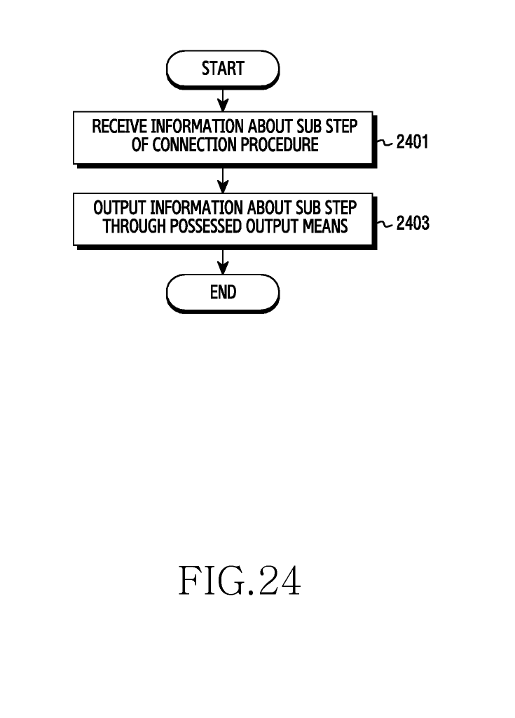

FIG. 24 is a flowchart of an operation procedure of an electronic device, according to another embodiment of the present disclosure.

Referring to FIG. 24, an operation method of the electronic device 1510 for expressing information about a connection procedure carried out with external electronic device 1520 is provided.

In step 2401, the electronic device 1510 receives information about a sub-step of the connection procedure from the external electronic device 1520. The information about the sub-step indicates a sub-step currently in progress.

Thereafter, the electronic device 1510 proceeds to step 2403 and outputs the information about the current sub-step. A scheme of outputting the information about the sub-step depends on an output means possessed by the electronic device 1510. For example, the information about the sub-step may be outputted in a form of at least one of an image, a character, a numeral, a sound, lighting, displaying, and vibrating.

In the embodiment illustrated in FIG. 24, the electronic device 1510 receives the information about the sub-step from the external electronic device. Alternatively, step 2401 may be omitted. That is, because the electronic device 1510, a subject of the connection procedure, joins the connection procedure, the electronic device 1510 determines the sub-step for itself without a notification from the external electronic device 1520. Accordingly, in case that the electronic device 1510 possesses a capability capable of determining the current sub-step, step 2401 may be omitted.

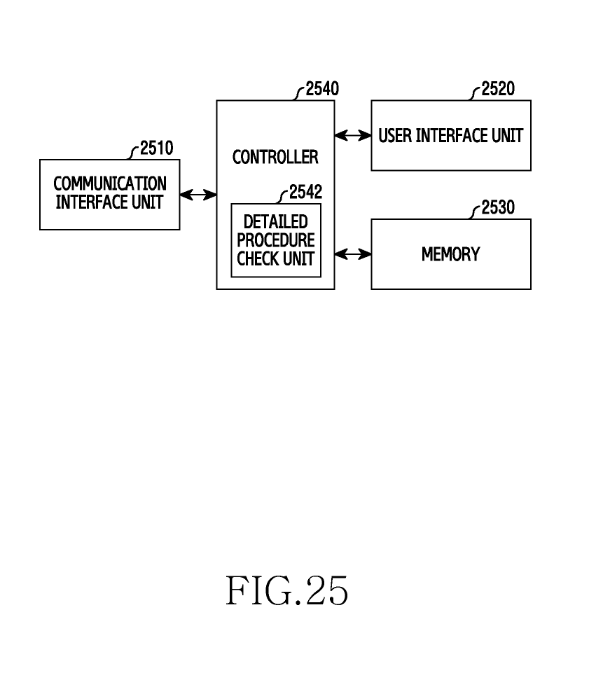

FIG. 25 is a block diagram of a configuration of an electronic device, according to an embodiment of the present disclosure.

Referring to FIG. 25, the electronic device 2500 is provided. The electronic device 2500 performs the function of the electronic device 1010 described with respect to FIG. 10, electronic device 1510 described with respect to FIG. 15, and electronic device 1810 described with respect to FIG. 18. The electronic device 2500 includes a communication interface unit 2510, a user interface unit 2520, a memory 2530, and a controller 2540.

The communication interface unit 2510 provides a function for allowing the electronic device 2500 to perform communication with an external device (e.g., the external device 1020 of FIG. 10, the external device 1520 of FIG. 15, and the external devices 1820-1, 1820-2, and 1820-3 of FIG. 18). For example, the communication interface unit 2510 performs a function for performing communication with the external device connected through a channel, through wireless communication or wired communication. In detail, the communication interface unit 2510 performs a function for transmitting/receiving a signal through a wireless channel, such as signal band conversion, amplification, etc., and performs a signaling and control procedure according to a protocol defined in an adopted communication standard. The communication interface unit 2510 supports a plurality of other communication standards and, for this, may include a plurality of modules. For example, the communication interface unit 2510 may include at least one of a transmission filter, a reception filter, an amplifier, a mixer, an oscillator, a Digital to Analog Converter (DAC), and an Analog to Digital Converter (ADC). The communication interface unit 2510 may be referred to as a ‘transmission unit’, a ‘reception unit’, a ‘transmission/reception unit’, a ‘communication unit’, etc. in that the communication interface unit 2510 transmits and receives a signal.

The user interface unit 2520 performs functions for outputting information and sensing a user's input. The user interface unit 2520 forwards an instruction or data input from a user, to the controller 2540. For this, the user interface unit 2520 may include at least one hardware module for the output and input. For example, the hardware module may include at least one of a sensor, a keyboard, a keypad, a speaker, a microphone, a touchscreen, an LCD, an LED, an LPD, an OLED, an AMOLED, and a FLED. For example, the user interface unit 2520 provides data about a user's touch input through a touchscreen, to the controller 2540. Particularly, the user interface unit 2520 displays information about a current sub-step determined by the controller 2540. Also, the user interface unit 2520 outputs an instruction or data received from the controller 2540, through an input/output device (e.g., a speaker or display).

The memory 2530 stores data such as a basic program for an operation of the electronic device 2500, an application program, setting information, etc. Particularly, the memory 2530 stores a program for determining a sub-step among a connection procedure for an external device, a program for outputting procedure information about the determined sub-step, and a program for proceeding to a next sub-step, etc.

The controller 2540 controls general operations of the electronic device 2500. For example, the controller 2540 transmits/receives a signal through the communication interface unit 2510. Also, the controller 2540 executes a program stored in the memory 2530, and records and reads data in the memory 2530. For this, the controller 2540 may include at least one processor. For example, the controller 2540 may include a Communication Processor (CP) performing control for communication and an Application Processor (AP) controlling an upper layer, such as an application program. The controller 2540 includes a detailed procedure check unit 2542 for monitoring progress states of sub-steps of a connection procedure with an external device. For example, the controller 2540 controls the electronic device 2500 to perform procedures illustrated in FIG. 3, FIG. 10, FIG. 14, FIG. 15, FIG. 16, FIG. 18, FIG. 19, FIG. 20, FIG. 21, and FIG. 22.

The controller 2540 determines a sub-step of a connection procedure. The controller 2540 determines at least one external device belonging to a specific sub-step selected by a user, or determines the current sub-step of at least one external device which is proceeding with the connection procedure. The controller 2540 displays an interface element showing the sub-step through the user interface unit 2520. The sub-step may be expressed with at least one of a graphic pattern of the interface element, a color of the interface element, a combination state of figures constructing the interface element, and a height or length of a 3D rendering object constructing the interface element.

The controller 2540 further displays supplementary information about the external device, in addition to the information about the sub-step. For example, the supplementary information is displayed by a user selecting an external device. The supplementary information may be displayed through a pop-up window. Or, in case that the sub-step is expressed using a 3D rendering object, the supplementary information is displayed on at least one of the sides of the 3D rendering object. Or, the supplementary information may be displayed using the 3D rendering object. In this case, the 3D rendering object having a height or length proportional to a value of the supplementary information is displayed. After the supplementary information is displayed, the controller 2540 sequentially displays supplementary information of different content in accordance with a predefined user's instruction. The user's instruction may be defined as a gesture (e.g., eye blinking).

The controller 2540 transmits image data displaying the information about the sub-step, to the external device through the communication interface unit 2510. Also, the controller 2540 transmits the information about the sub-step or the image data displaying the information about the sub-step, to a second electronic device, which is not a part of the connection procedure, through the communication interface unit 2510. For example, the second electronic device (e.g., second electronic device 1030 of FIG. 10, the second electronic device 1530 of FIG. 15, and the second electronic device 1830 of FIG. 18) may be a device having a display means bigger than that of the controller 2540, or may be a wearable device (e.g. wearable device 1540 of FIG. 15).

The controller 2540 displays the cause of interruption of an interrupted sub-step. The interruption cause may be displayed when a corresponding external device is selected by a user, or may be displayed together with information notifying of the interruption. Together with the interruption cause, supplementary information about the external device may be displayed together. When, the controller 2540 senses a user's instruction of requesting the re-execution of the interrupted sub-step, the controller 2540 re-executes the interrupted sub-step. That is, the controller 2540 displays an interface element for requesting the re-execution of the sub-step through the user interface unit 2520. For example, the interface element may include a button. Or, when the sub-step is expressed by a combination state of a plurality of figures, the request for the re-execution of the sub-step may be triggered by dragging, in different directions, two figures combined due to the completion of the corresponding sub-step such that the two figures become distant from each external.

The controller 2540 transmits information about the external device, to a server (e.g. server 1050 of FIG. 10 or server 1550 of FIG. 15) through the communication interface unit 2510. The server may exist in an external network. For example, the server may be a cloud server. The information about the external device includes at least one of identification information of the external device, a network status, and a geographical location of the external device. In addition, the controller 2540 transmits information about the controller 2540, together. After receiving an estimated time for each sub-step of a connection procedure, from the server through the communication interface unit 2510, the controller 2540 displays the estimated time through the user interface unit 2520. For example, the estimated time may be displayed together with information about each sub-step. And, after the completion of each sub-step, the controller 2540 transmits the actual time for performing a corresponding sub-step to the server through the communication interface unit 2510.

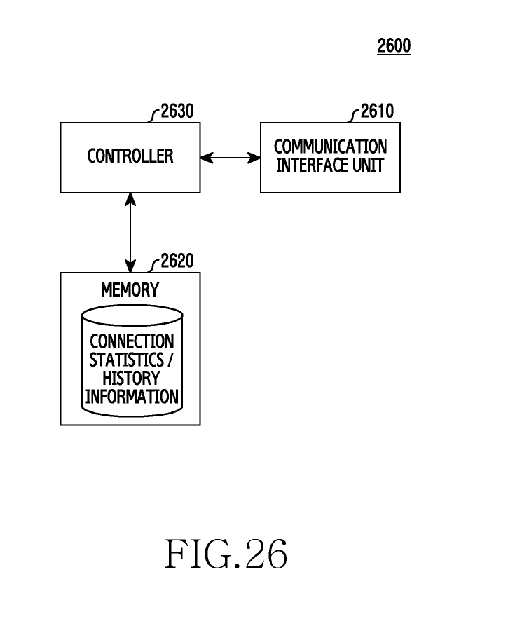

FIG. 26 is a block diagram of a configuration of a server managing information about a connection procedure, according to an embodiment of the present disclosure.

Referring to FIG. 26, a server 2600 is provided. The server 2600 performs the function of the server 1050 described with respect to FIG. 10 and server 1550 described with respect to FIG. 15. The server 2600 includes a communication interface unit 2610, a memory 2620, and a controller 2630.

The communication interface unit 2610 provides a function for allowing the server 2600 to perform communication with an electronic device (e.g. the electronic device 1010 of FIG. 10, electronic device 1510 of FIG. 15 and the electronic device 1810 of FIG. 18). That is, the communication interface unit 2610 converts a bit stream transmitted by the server 2600 to a node into a physical signal, and converts a physical signal received from the node into a bit stream. That is, the communication interface unit 2610 transmits and receives a signal. Accordingly, the communication interface unit 2610 is called a ‘transmission unit’, a ‘reception unit’, a ‘transmission/reception unit’, and a ‘communication unit’.

The memory 2620 stores data such as a basic program for an operation of the server, an application program, setting information, etc. The memory 2620 stores information about a history and statistics of performance time of sub-steps of the previous connection procedures performed between an electronic device and an external device (e.g. the external device 1020 of FIG. 10, external device 1520 of FIG. 15 and the external devices 1820-1, 1820-2, and 1820-3 of FIG. 18).

The controller 2630 controls general operations of the server 2600. For example, the controller 2630 transmits/receives a signal through the communication interface unit 2610. Also, the controller 2630 executes a program stored in the memory 2620, and records and reads data in the memory 2620. For this, the controller 2630 may include at least one processor. The controller 2630 provides an estimated time for sub-steps of a connection procedure, to an electronic device performing a connection. For example, the controller 2630 controls the server 2600 to perform the operation of the server 1050 of FIG. 10, the operation of the server 1550 of FIG. 15, and the procedure illustrated in FIG. 23.

The controller 2630 receives at least one of information about an external device to connect with an electronic device and information about the electronic device, from the electronic device through the communication interface unit 2610. For example, the information about the external device includes at least one of identification information of the external device, a network status, and a geographical location of the external device. And, the controller 2630 transmits an estimated time for each sub-step of a connection procedure to the electronic device through the communication interface unit 2610. That is, the controller 2630 determines the estimated time on the basis of information about a history and statistics of actual performance times of sub-steps of previous connection procedures stored in the memory 1620, and provides the estimated time. In addition, the controller 2630 receives an actual time for performing each sub-step from the electronic device through the communication interface unit 2610. Accordingly, the controller 2630 updates the information about the history and statistics stored in the memory 2620 using information experienced by the electronic device.

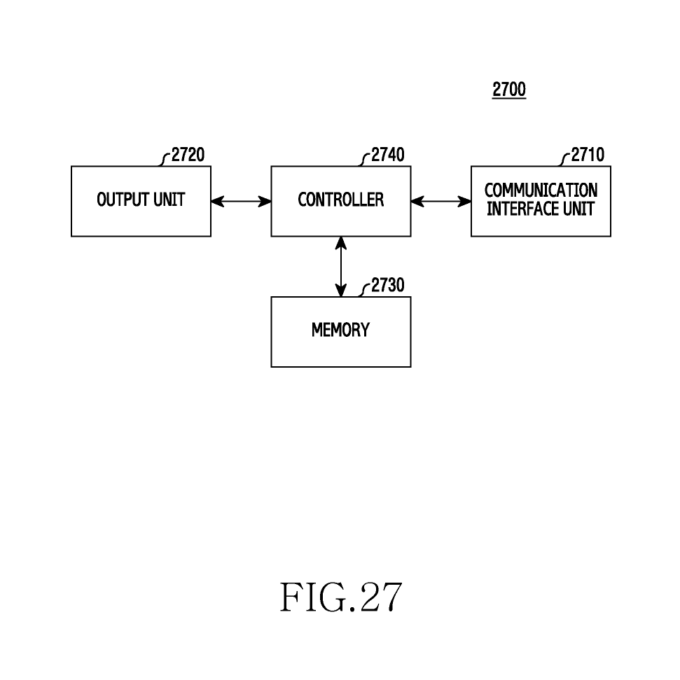

FIG. 27 is a block diagram of a configuration of an external device, according to another embodiment of the present disclosure.

Referring to FIG. 27, an external device 2700 is provided. The external device 2700 performs the function of the external device 1020 described with respect to FIG. 10, electronic device 1520 described with respect to FIG. 15, and external devices 1820-1, 1820-2, and 1820-3 described with respect to FIG. 18. The external device 2700 includes a communication interface unit 2710, an output unit 2720, a memory 2730, and a controller 2740.

The communication interface unit 2710 provides a function for allowing the external device 2700 to perform communication with an electronic device (e.g., such as electronic device 1010 of FIG. 10, 1510 of FIG. 15 and 1810 of FIG. 18). For example, the communication interface unit 2710 performs a function for performing communication with the electronic device connected through a channel, through wireless communication or wired communication. In detail, the communication interface unit 2710 performs a function for transmitting/receiving a signal through a wireless channel, such as signal band conversion, amplification, etc., and performs a signaling and control procedure according to a protocol defined in an adopted communication standard. The communication interface unit 2710 supports a plurality of other communication standards and, for this, includes a plurality of modules. For example, the communication interface unit 2710 may include at least one of a transmission filter, a reception filter, an amplifier, a mixer, an oscillator, a DAC, and an ADC. The communication interface unit 2710 may be referred to as a ‘transmission unit’, a ‘reception unit’, a ‘transmission/reception unit’, a ‘communication unit’, etc., in that the communication interface unit 2710 transmits and receives a signal.

The output unit 2720 outputs information. The output unit 2720 may be different according to the kind of the external device. For example, the output unit 2720 includes at least one of a display window providing visual information, an LED, a speaker providing auditory information, and a vibrating module. Accordingly, the output unit 2720 may output information in a form of at least one of an image, a character, a numeral, a sound, lighting, displaying, and vibrating.

The memory 2730 stores data such as a basic program for an operation of the external device 2700, an application program, setting information, etc. The memory 2730 provides the stored data in response to a request of the controller 2740.

The controller 2740 controls general operations of the external device 2700. For example, the controller 2740 transmits/receives a signal through the communication interface unit 2710. Also, the controller 2740 executes a program stored in the memory 2730, and records and reads data in the memory 2730. For this, the controller 2740 includes at least one processor. The controller 2740 outputs information about the current sub-step among a connection procedure with electronic device, through the output unit 2720. For example, the controller 2740 controls the external device 2700 to perform the operations of the external devices 1020 of FIG. 10, external device 1520 of FIG. 15, external devices 1820-1 to 1820-3 of FIG. 18, and the procedure illustrated in FIG. 24.

The controller 2740 receives information about a sub-step of the connection procedure from the electronic device through the communication interface unit 2710. The information about the sub-step indicates a sub-step being currently in progress. The controller 2740 outputs the information about the current sub-step. A scheme of outputting the information about the sub-step depends on the output unit 2720. For example, the information about the sub-step may be output in a form of at least one of an image, a character, a numeral, a sound, lighting, displaying, and vibrating.

Alternatively, the operation of receiving the information about the sub-step may be omitted. That is, because the electronic device 2700, a subject of the connection procedure, joins the connection procedure, the electronic device 2700 may determine the sub-step for itself without a notification from the external device. Accordingly, in case that the electronic device 2700 possesses a capability of determining the current sub-step, the operation of receiving the information about the sub-step may be omitted.

The methods according to the embodiments mentioned herein may be implemented in a form of hardware, software, or a combination of hardware and software.

If the methods are implemented by the software, a computer-readable storage medium storing one or more programs (i.e., software modules) is provided. The one or more programs stored in the computer-readable storage medium are configured to be executed by one or more processors within an electronic device. The one or more programs include instructions for enabling the electronic device to execute the methods according to the embodiments described herein.

These programs (i.e., software modules or software) may be stored in a Random Access Memory (RAM), a non-volatile memory including a flash memory, a Read Only Memory (ROM), an Electrically Erasable Programmable ROM (EEPROM), a magnetic disk storage device, a Compact Disk ROM (CD-ROM), a Digital Versatile Disk (DVD) or an optical storage device of other form, and a magnetic cassette. Alternatively, the programs may be stored in a one or more memories constructed by a combination of some or all of the above.

Also, the programs may be stored in an attachable storage device accessible through a communication network such as the Internet, an intranet, a LAN, a WLAN, and a Storage Area Network (SAN) or a communication network constructed by a combination of the foregoing. This storage device may connect to a device performing an embodiment of the present disclosure through an external port. Also, a separate storage device on the communication network may connect to a device performing an embodiment of the present disclosure as well.

In the aforementioned embodiments of the present disclosure, a constituent element included in an embodiment of the present disclosure has been expressed in the singular number or the plural number in accordance to the proposed embodiments. However, the expression of the singular number or plural number is selected suitable to a situation proposed for description convenience, and it is not that the scope of the present disclosure is limited to singular or plural constituent elements. A constituent element expressed in the plural number may be constructed in the singular number, and a constituent element expressed in the singular number may be constructed in the plural number.

While the disclosure has been shown and described with reference to certain embodiments described herein, it will be understood by those skilled in the art that various changes in form and details may be made therein without departing from the spirit and scope of the disclosure as defined by the appended claims. Therefore, the scope of the present invention is defined not by the detailed description of the present invention, but by the appended claims and their equivalents, and thus, all differences within the scope will be construed as being included in the present invention.

What is claimed is:

1. A method for operating a first electronic device in a network, the method comprising:
determining a sub-step in progress among a plurality of sub-steps of a connection procedure with a second electronic device; and
displaying information about the sub-step.

2. The method of claim 1, wherein displaying the information about the sub-step comprises displaying one of a screen for displaying a list of a plurality of external electronic devices including the second electronic device which is proceeding with a sub-step selected by a user, and a screen for notifying of a sub-step in progress of each of the plurality of external electronic devices including the second electronic device.

3. The method of claim 1, wherein displaying the information about the sub-step comprises displaying the cause of interruption of the sub-step.

4. The method of claim 1, further comprising:
detecting a user's instruction for requesting re-execution of the sub-step; and
re-executing the sub-step.

5. The method of claim 1, wherein displaying the information about the sub-step comprises displaying an interface element representing the sub-step in progress,
wherein the sub-step is expressed with at least one of a graphic pattern of the interface element, a color of the interface element, a combination state of figures constructing the interface element, and a height of a 3-Dimension (3D) rendering object constructing the interface element.

6. The method of claim 1, wherein displaying the information about the sub-step comprises displaying an estimated time for performing the sub-step.

7. The method of claim 6, further comprising:
transmitting information about the second electronic device to a server; and
receiving the estimated time from the server.

8. The method of claim 7, further comprising, after completion of the sub-step, transmitting an actual time for performing the sub-step to the server.

9. The method of claim 1, further comprising transmitting image data displaying the information about the sub-step to the second electronic device.

10. The method of claim 1, further comprising transmitting at least one of the information about the sub-step and image data displaying the information about the sub-step to a third electronic device.

11. The method of claim 1, further comprising displaying supplementary information about the second electronic device.

12. The method of claim 11, wherein displaying the supplementary information comprises displaying the supplementary information on at least one of sides of a 3-Dimension (3D) rendering object displaying the sub-step.

13. The method of claim 11, wherein displaying the supplementary information comprises sequentially displaying supplementary information of different content, in accordance with a user's instruction.

14. The method of claim 11, wherein displaying the supplementary information comprises displaying 3D rendering objects having heights proportional to values of supplementary information about each of a plurality of electronic devices including the second electronic device.

15. A method for operating a second electronic device in a network, the method comprising:
outputting information about a sub-step in progress among a plurality of sub-steps of a connection procedure with a first electronic device, during the connection procedure,
wherein the information about the sub-step is output in a form of at least one of an image, a character, a numeral, a sound, lighting, displaying, and vibrating.

16. The method of claim 15, further comprising receiving the information about the sub-step from the first electronic device.

17. A method of a server managing information about a connection procedure between electronic devices, the method comprising:
receiving, from a first electronic device, information about a second electronic device to connect with the first electronic device; and
transmitting an estimated time for performing at least one of a plurality of sub-steps of a connection procedure between the first electronic device and the second electronic device.

18. The method of claim 17, further comprising receiving an actual time for performing at least one of the plurality of sub-steps, from the first electronic device.

19. A first electronic device in a network, the first electronic device comprising:
a controller that determines a sub-step in progress among a plurality of sub-steps of a connection procedure with a second electronic device; and
a display unit that displays information about the sub-step.

20. The device of claim 19, wherein the display unit displays one of a screen for displaying a list of a plurality of external electronic devices including the second electronic device which is proceeding with a sub-step selected by a user, and a screen for notifying of a sub-step in progress of each of the plurality of external electronic devices including the second electronic device.

21. The device of claim 19, wherein the display unit displays the cause of interruption of the sub-step.

22. The device of claim 19, wherein the controller detects a user's instruction for requesting re-execution of the sub-step, and re-executes the sub-step.

23. The device of claim 19, wherein the display unit displays an interface element representing the sub-step in progress, and
the sub-step is expressed with at least one of a graphic pattern of the interface element, a color of the interface element, a combination state of figures constructing the interface element, and a height of a 3-Dimension (3D) rendering object constructing the interface element.

24. The device of claim 19, wherein the display unit displays an estimated time for performing the sub-step.

25. The device of claim 24, further comprising a communication unit that transmits information about the second electronic device to a server, and receiving the estimated time from the server.

26. The device of claim 25, wherein, after completion of the sub-step, the communication unit transmits an actual time for performing the sub-step to the server.

27. The device of claim 19, further comprising a communication unit that transmits image data displaying the information about the sub-step to the second electronic device.

28. The device of claim 19, further comprising a communication unit that transmits at least one of the information about the sub-step and image data displaying the information about the sub-step to a third electronic device.

29. The device of claim 19, wherein the display unit displays supplementary information about the second electronic device.

30. The device of claim 29, wherein the display unit displays the supplementary information on at least one of sides of a 3-Dimension (3D) rendering object displaying the sub-step.

31. The device of claim 29, wherein the display unit sequentially displays supplementary information of different content, in accordance with a user's instruction.

32. The device of claim 29, wherein the display unit displays 3D rendering objects having heights proportional to values of supplementary information about each of a plurality of electronic devices including the second electronic device.

33. A second electronic device in a network, the second electronic device comprising
an output unit that outputs information about a sub-step in progress among a plurality of sub-steps of a connection procedure with a first electronic device, during the connection procedure,
wherein the information about the sub-step is output in a form of at least one of an image, a character, a numeral, a sound, lighting, displaying, and vibrating.

34. The device of claim 33, further comprising a communication unit that receives the information about the sub-step from the first electronic device.

35. A server apparatus managing information about a connection procedure between electronic devices, the server apparatus comprising:
a reception unit that receives, from a first electronic device, information about a second electronic device to connect with the first electronic device; and
a transmission unit that transmits an estimated time for performing at least one of a plurality of sub-steps of a connection procedure between the first electronic device and the second electronic device.

36. The device of claim 35, wherein the reception unit receives an actual time for performing at least one of the plurality of sub-steps, from the first electronic device.
